(19) United States
(12) Patent Application Publication
(10) Pub. No.: US 2007/0057115 A1
(43) Pub. Date: Mar. 15, 2007

(54) Control system for craft and a method of controlling craft

(76) Inventor: John William Newton, Leighton Buzzard (GB)

Correspondence Address: SNELL & WILMER, 400 EAST VAN BUREN, ONE ARIZONA CENTER, PHOENIX, AZ, 85004-2202, US

(21) Appl. No.: 10/554,714

(22) PCT Filed: Apr. 29, 2004
(86) PCT No.: PCT/GB04/01846

§ 371 Date: Nov. 6, 2006

(30) Foreign Application Priority Data
Apr. 29, 2003 (GB) 0310010.4

(51) Int. Cl. B64C 5/00

(52) U.S. Cl. 244/89

(57) ABSTRACT

A control system for a missile (11) having a moving wing (12) and moving tail (13) which have synchronised operation for automated variable displacement. The system provides improved manoeuvrability allowing enhanced look and impact. The system is also applicable to aircraft, marine craft and UAV craft.

The present invention relates to a control system for craft and a method of controlling craft.

### BACKGROUND OF THE INVENTION

In conventional aircraft, the pilot sets the wing flap for landing configuration, take-off or go-around. He then uses elevator control to trim and pitch the aircraft according to requirement i.e. flare into landing or pull up into take-off.

One type of conventional missile has a fixed main wing and a movable tail surface. Another type of conventional missile has a smaller forward movable canard as a front surface, and a larger wing behind it.

U.S. Pat. No. 4,967,984 concerns the implementation of a free wing concept to a light aircraft configuration. The primary objective is stress alleviation of all lifting surfaces under turbulent and gust encounter. In applying this principle, both wing and tail surfaces are free to rotate involving departure from a steady state condition under atmospheric disturbance where the initial steady state is governed by a pilot control.

GB Patent Specification No. 462 382 involves an aircraft with a tandem wing arrangement each wing with flap controls mechanically linked to achieve improved manoeuvre under pitch control through two combined control mechanisms on the same control column. The ability to control pitch attitude response through the differential control of forward and aft lifting surface flaps is intended to do away with the need for a tailplane thereby offering the prospect of a shorter length aircraft than usual.

GB Patent Specification No. 547,397 involves a tandem wing aircraft and tailplane with elevator control. The two forward wing surfaces are mechanically linked through the pilot control column to achieve a differential pitch deflection as the pilot control column is moved forward and aft. The objective is the reduction of aircraft width and length through the use of the tandem wing arrangement.

The tandem wing arrangement is mechanically actuated to provide a fixed geared rotation of both forward and aft wing surfaces. This gearing ratio is fixed on the ground by mechanical adjustment of the control linkage rods attached to each wing and the control column and as such is a fixed discrete method of control.

### SUMMARY OF THE INVENTION

According to the present invention, there is provided a control system for a craft having two wing control surfaces spaced apart along a main body section of the craft, the system comprising automated synchronized operation of the two wing control surfaces for continuous variable displacement for manoeuvre of the main body relative to the flight path velocity vector.

The control system of the present invention may include any one or more of the following preferred features:
automated synchronised operation provides identical rotational and/or translational movement of the two control surfaces;
automated synchronised operation provides proportional rotational and/or translational movement of the two control surfaces;
automated synchronised operation provides geared rotational and/or translational movement of the two control surfaces;
automated synchronised operation provides variable rotational and/or translational movement of the two control surfaces;
means to off-set the body axis relative to the instantaneous flight path velocity vector;
means to effect an applied manoeuvre about an instantaneous zero lift line;
means to adjust, at predetermined time intervals, the control surfaces setting to effect configuration of the zero lift line manoeuvre.

The system may include the features of any one or more of dependent claims 2 to 29.

Preferably, the gearing between the two wing surfaces (e.g. wing and tail control) deflection is variable. As such it is considered to be a soft control. The ratio of the wing to tail control deflection is aimed purely at controlling the zero lift line on a continuous basis. In the case of missiles, this improves seeker-maintained lock onto the target under manoeuvre as well as achieving ideal terminal trajectory shaping in order to impact the target with a high probability of kill.

Thus, when a complete wing is deflected as a control surface, the local wing+body combined zero lift line is changed. The same argument applies to a fully moving tail in combination with the body. Where the two move as in the current invention, then the overall body experiences a change in zero lift line. Fully moving surfaces are in keeping with missile methods of control.

In cases where the wing and tail is fixed to the body with only a trailing edge flap offering control, the lifting surface to which it is attached experiences a local change in zero lift line similar to that for a fully moving surface as the flap is deflected. If both the wing and tail surface comprise trailing edge flaps, then there is again an overall body change in zero lift line due to the combined effect of deflecting one or both sets of controls in any order. Lifting surfaces, whether acting as a wing or tail surface which operate a trailing edge flap, are more in keeping with UAV's and civil/military aircraft.

The present invention also provides a craft having a control system of the present invention.

According to the present invention, there is also provided a method of controlling a craft having two wing control surfaces spaced apart along a main body section of the craft, the method comprising automated synchronized operation of the two wing control surfaces for continuous variable displacement for manoeuvre of the main body relative to the flight path velocity.

The method may include any one or more of the following preferred features:
automated identical rotational and/or translational movement of the main and secondary control surfaces;
automated proportional rotational and/or translational movement of the main and secondary control surfaces;
automated geared rotational and/or translational movement of the main and secondary control surfaces;
automated varied rotational and/or translational movement of the main and secondary control surfaces;
off-setting the body axis relative to the instantaneous flight path velocity vector;
effecting an applied manoeuvre about an instantaneous zero lift line;
adjusting at predetermined time intervals, the control surfaces settings to effect configuration of the zero lift line manoeuvre;
controlling, selectively as required, to provide:
   constant speed;
   variable speed;
   proportional rotational and/or translational movement of control surfaces;
   geared rotational and/or translational movement of control surfaces;
   variable rotational and/or translational movement of control surfaces.

The method may include the features of any one or more of dependent claims 32 to 59.

According to the present invention, there is also provided a computer program product directly loadable into the internal memory of a digital computer, comprising software code portions for performing the method of the present invention when said product is run on a computer.

According the present invention, there is also provided a computer program directly loadable into the internal memory of a digital computer, comprising software code portions for performing the method of the present invention when said program is run on a computer.

According to the present invention, there is also provided a carrier, which may comprise electronic signals, for a computer program embodying the present invention.

According to the present invention, there is also provided electronic distribution of a computer program product, or a computer program, or a carrier of the present invention.

### ADVANTAGES OF THE PRESENT INVENTION

The present invention as described herein may provide the following advantage of greater control over body angle of attack during flight which enables configuring the airframe for optimal fuel efficiency. In this way, the present invention may extend range or improve ground seeker sweep area for target acquisition and height holding/terrain following functions.

When used in missiles or torpedoes, the present invention may provide one or more of the following advantages:

Maintaining manoeuvreability right down to impact, with zero grazing incidence at impact. This improves warhead probability of kill and so improved warhead efficiency;

Better shaping of terminal trajectory with higher probability of impacting the target at lower angles to the vertical, thereby improving probability of kill at impact due to improved warhead efficiency;

Improved terminal performance upon impact (for both fixed and moving targets);

Greater control over the missile into the terminal phase trajectory. Thus there is an improved ability to maintain “lock-on” of the seeker equipment onto the target without the loss which usually results from the seeker hitting look angle limits;

Longer time for doing the processing operations to determine if a “locked-onto” target is hostile or friendly;

Actuating a wing under constant or variable flight speed control to reduce the need for significant actuation torque, resulting in reduction of the size and cost of actuation mechanism.

In the present invention, the body incidence (angle between axis of symmetry and flight path vector) can be zero leaving the inter-linked wing and tail surfaces under deflection to achieve the required manoeuvre g by providing the necessary latax force.

Advantageously, the present invention may provide continuous control of all fully-moving control lifting surfaces, with or without auxiliary control flaps, in order to alter the main body (fuselage) attitude continuously to maintain a steady directional field of view in level flight and under manoeuvre.

Also, there may be independent continuous actuation of forward and aft wing control surfaces so that transient effects of vortex loading from the forward lifting control surfaces to the aft lifting control surfaces under manoeuvre may be corrected for in maintaining the desired attitude control. Similar arguments apply to turbulent air and gust encounter.

These features are not possible in the conventional systems described above.

Additional novel features are:
controls may be continuously adjusted to rotate the zero lift line normal to which the manoeuvre is initiated in order to maintain the directional field of view;
manoeuvring involves complex coupled dynamic behaviour and may be executed under the control of an autopilot control system in which an appropriate control routine adopting motion sensor inputs ensures the required response;
with all lifting surfaces fully moving, a control routine can be defined which ensures that any transient loads resulting from lateral manoeuvre and acting along the body, (acting principally at the lifting control stations), and can be anticipated via motion sensors and corrected for in maintaining control of the main body attitude. This is instead of reacting to the moment induced by these forces, as would be the case if one or both forward or aft control lifting surfaces was fixed to the fuselage with control flaps providing the method of control.

These above features provide the benefit of improved field of view, especially in relation to aircraft, marine craft and UAV craft.

Furthermore, the present invention may incorporate the combined deflection of all lifting control surfaces and the main body to maintain level flight with minimum drag for optimal fuel efficiency, thereby providing improved endurance.

The present invention may also provide the following features:
continuous control of all fully moving control lifting surfaces, thereby to alter the main body attitude continuously to maintain a steady directional field of view onto a target while manoeuvring;
controls may be continuously adjusted to rotate the zero lift line normal to which the manoeuvre is initiated in order to maintain the directional field of view of any homing device onto the target;
independent actuation of forward and aft wing control surfaces to correct for transient effects of vortex carry-over loading from the forward lifting control surfaces to the aft lifting control surfaces under manoeuvre in maintaining the desired attitude control. Differential control deflection may be required to take out the moment on the missile body in the plain of manoeuvre that would otherwise result to deflect the field of view and destroy directional control.

These features may provide improved field of View in missile applications and homing performance in torpedo applications.

The present invention may also provide the following features:
all control lifting surfaces are fully moveable to achieve manoeuvre relative to the zero lift line with the zero lift line co-incident with the missile flight path velocity vector;
at impact a missile with warhead effective along the missile longitudinal body axis of symmetry strikes the target with zero grazing incidence and in so doing achieves maximum effectiveness;
improved trajectory shaping to achieve a top attack capability onto a target to provide considerable improvement over current weapon systems particularly in the ground attack role against either tanks or underground bunkers.

### APPLICATIONS OF THE PRESENT INVENTION

The present invention is applicable to aircraft, marine craft, missiles, torpedoes and unmanned airborne vehicles (UAV).

In recent years there has been a growing need to improve the “probability of kill” of missile warheads at target intercept. The current invention addresses this requirement through the application of a new method of control and terminal engagement routine. Although the invention has been derived in considering the targeting of ground based fixed or moving targets, the generic form of the invention will find application in targeting airborne targets also. There are further anticipated applications involving possibly torpedoes, UAV's and Lighter-than-air-Aircraft.

The invention results from the awareness that symmetric cruciform missiles, in service to date, comprise at least one pair of fixed lifting surfaces in addition to at least one pair of control surfaces in each orthogonal plane. The fact that one pair of surfaces are fixed means that, in putting on manoeuvre, the airframe must induce incidence under control deflection. Inherent in this feature is the inescapable fact that, if the missile manoeuvres onto a target then in pulling incidence to do so, it must strike the target with a grazing incidence. This results in a loss of missile “probability of kill” at impact since the warhead line of action is off axis from the flight path.

In the case of impact with reactive armour, warheads “in tandem” are often employed. The first warhead drives a hole in the armour, and the second (usually a fragmenting warhead) follows through the hole to destroy the target. If grazing incidence exists then the second warhead finds it difficult to enter the hole created by the first, hence the loss of effective “probability of kill”. If impact at zero grazing incidence is achieved, this problem is overcome.

One method by which the conventional missile achieves this, is to back off in manoeuvring onto the target, thereby striking it at zero grazing incidence and zero manoeuvre g's in the process. Although this improves the warhead “probability of kill” for the reasons mentioned above, it invariably means that the trajectory onto target has to be shallow, and target acquisition has to take place earlier than may prove desirable if the seeker acquisition range becomes a limiting factor.

Shallow trajectories may also reduce target “probability of kill” in the case of ground attack targets, since it forces the missile to negotiate the most reactive part of the target armour in the case of tanks.

Advantageously, the missile should attack the target at a steeper angle of approach to strike at the less-defended top part of the structure. For ground penetrating weapons (commonly known as ‘bunker busters’), a top attack is also advantageous since less earth needs to be penetrated in arriving at the underground bunker.

The present invention achieves zero grazing incidence at target impact whether the target is stationary or moving and with a high angle of approach (ground based target) by adopting a combination wing-tail control.

An important feature of the present invention is that, only by having all sets of lifting surfaces active as controls, is it possible to establish a Zero Lift Line off axis from the axis of symmetry of the missile, normal to which manoeuvre is indicated, thereby providing the ability to achieve the extremes of directional control of the body in a manner essential to achieving the required performance improvement over existing weapon and other aircraft and marine platforms.

This is an aspect which characterises this invention in its intended application. Consistent with most missile systems, a combination of wing and tail surfaces is adopted here although more than two sets of lifting surfaces may be employed.

An important feature of the invention is that a wing and tail deflection may be defined at an instant in time which identifies a unique Zero Lift Line and angle-to-missile body axis.

Conversely, if the Zero Lift Line is selected via the seeker to maintain favourable look angle onto the target, then there exists a unique combined deflection of Wing and Tail control surfaces to achieve this.

Also since the missile is manoeuvring at this time, it is understood that the force necessary to achieve this manoeuvre is accomplished by initiating a relative deflection to that Wing and Tail deflection which establishes the Zero Lift Line. The combined wing and tail deflection at any instant may therefore be selected via the seeker requirements to maintain look onto the target while also executing the manoeuvre onto the target required to maintain it within look angle limits.

If a terminal engagement routine is selected which ensures that this process delivers the missile at zero grazing incidence at target impact even while under manoeuvre and at high angle of approach angle then the requirements for a much improved weapon “probability of kill” at target impact may be achieved.

The present invention identifies a terminal engagement routine which accomplishes all these features and accordingly presents a unique solution to the process of improving “probability of kill”.

### GENERAL DESCRIPTION OF THE PRESENT INVENTION

In order that the present invention may more readily be understood, a description is now given, by way of example only, reference being made to the accompanying drawings, in which:

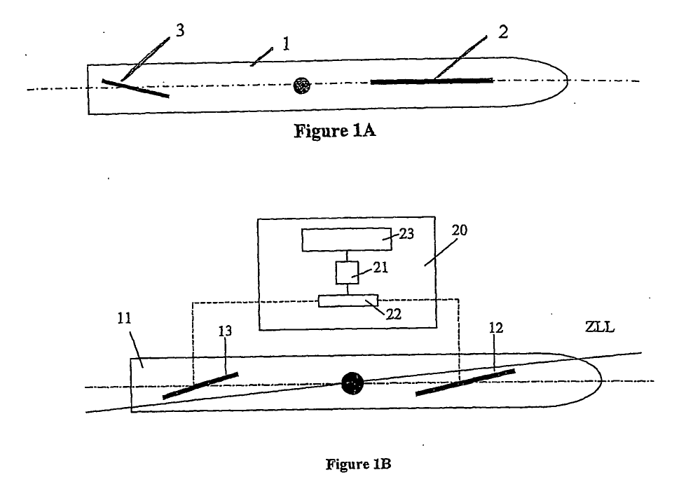

FIG. 1A is a schematic drawing of a missile with a conventional control system;

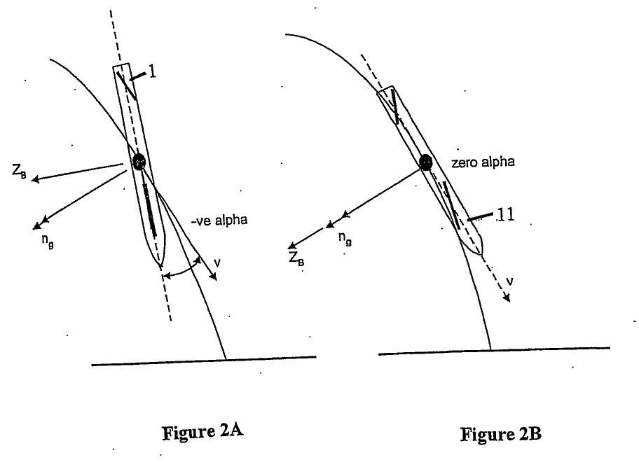

FIG. 2A shows the missile of FIG. 1 in an impact manoeuvre;

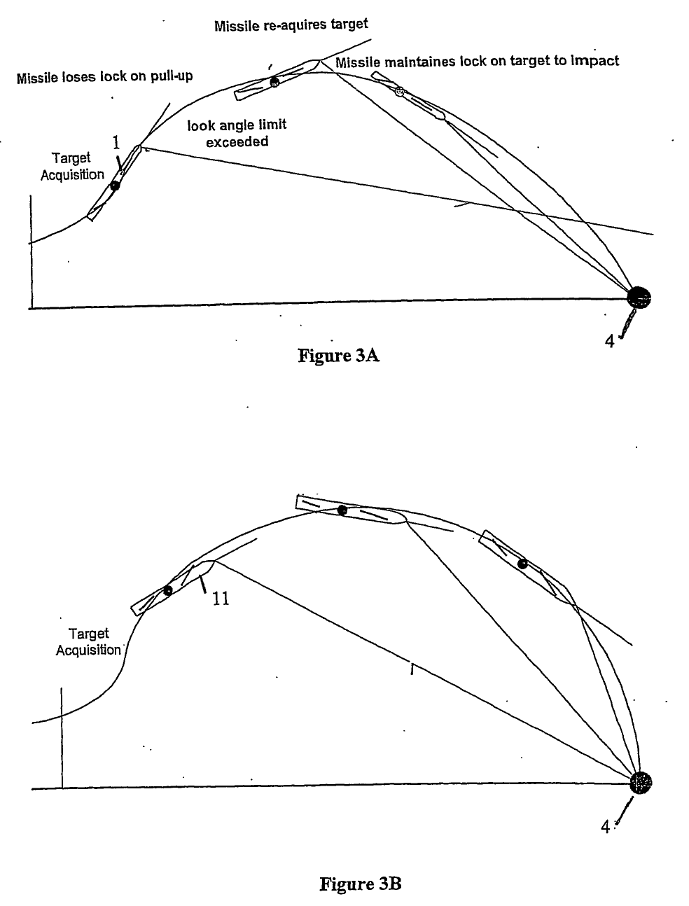

FIG. 3A shows the trajectory of the missile of FIG. 1;

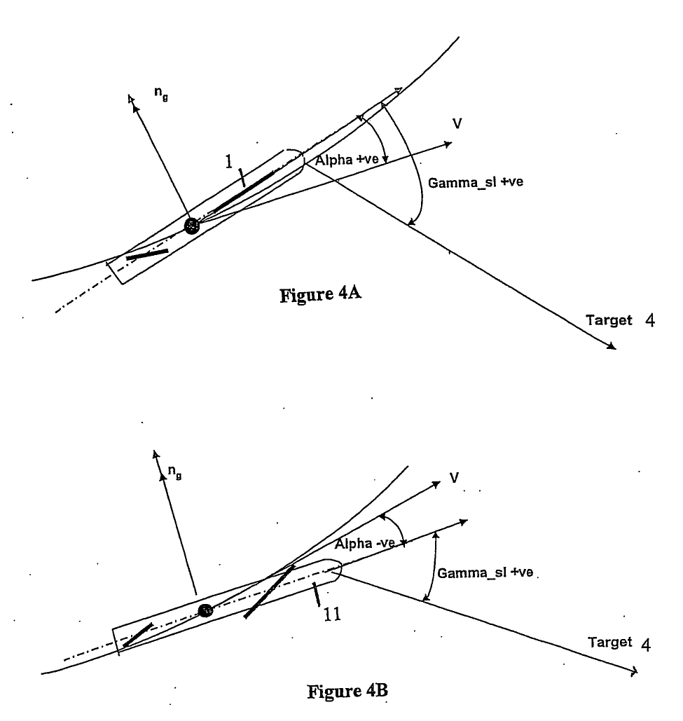

FIGS. 4A, 5A and 6A show schematically other features of a conventional missile;

FIGS. 1B to 6B show equivalent situations for a missile of the present invention;

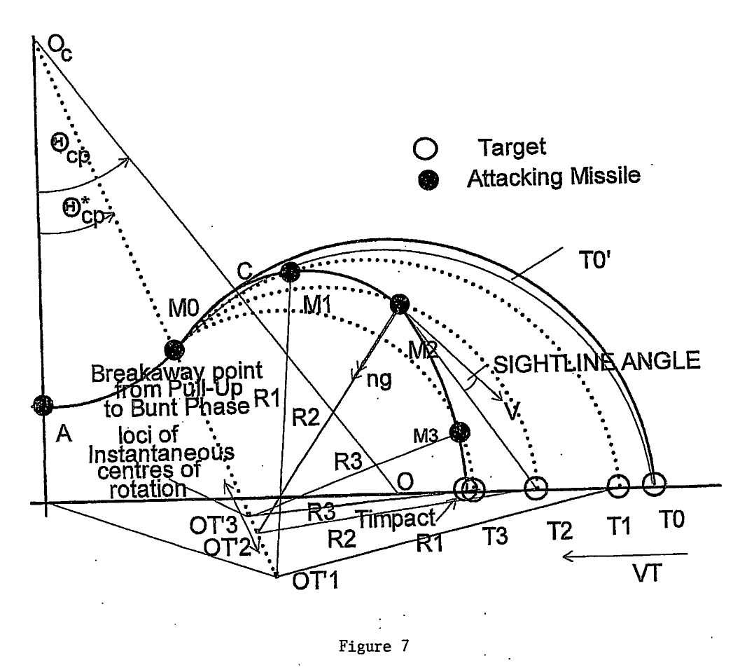

FIG. 7 shows another trajectory of a missile;

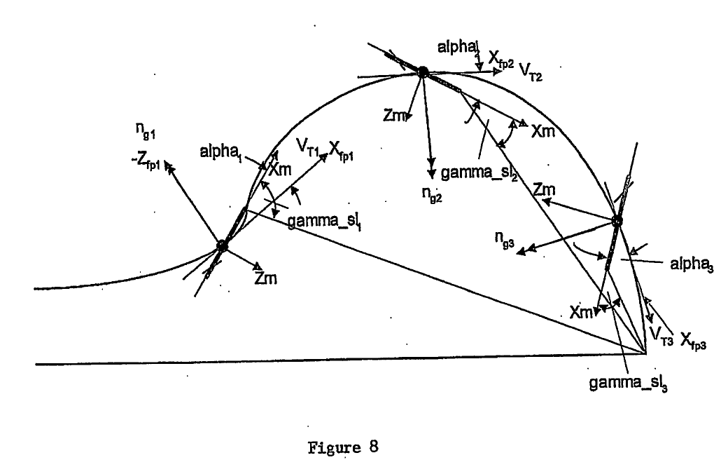

FIG. 8 shows the trajectory of a conventional missile;

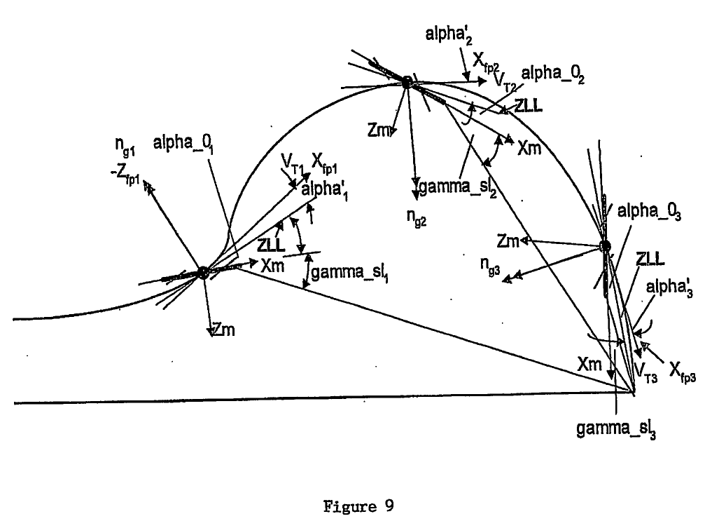

FIG. 9 is a further trajectory of a missile embodying the present invention; and

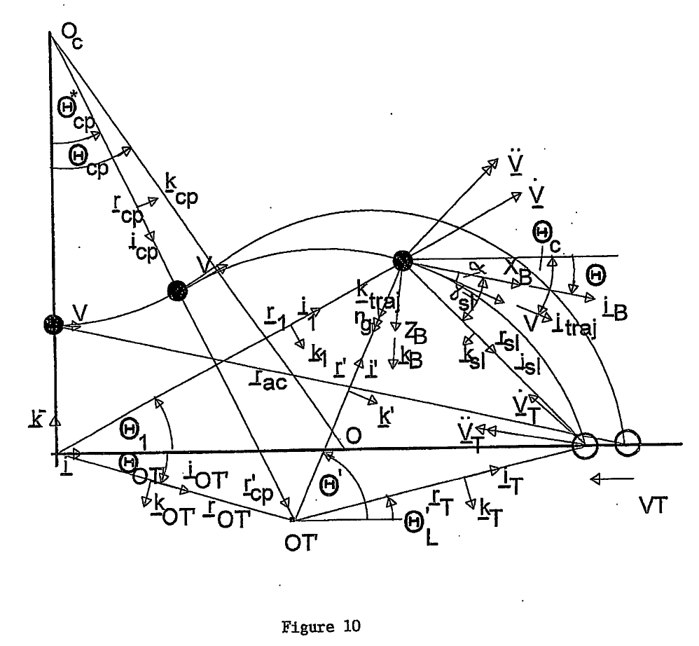

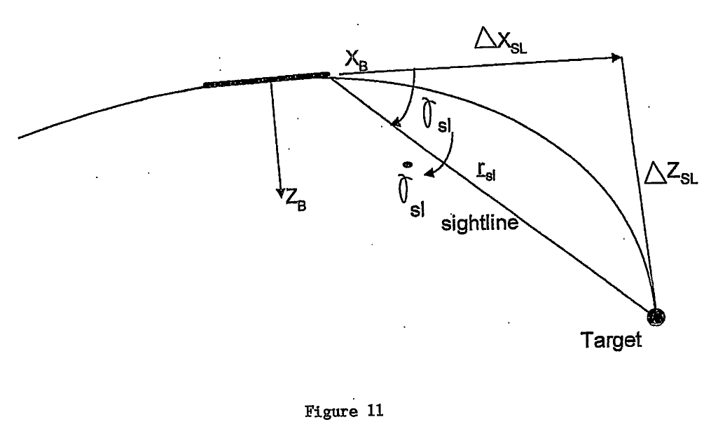

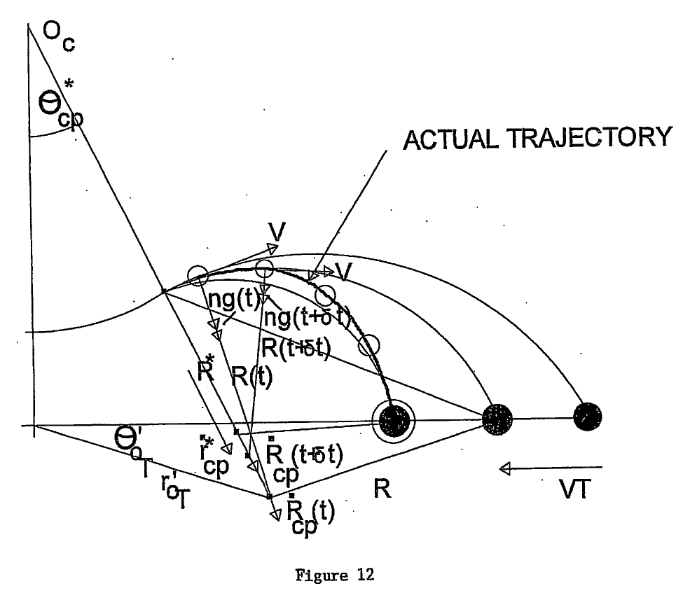

FIGS. 10 to 13 show a more detailed trajectory of a missile of the present invention.

### The present invention provides a wing and tail inter-linked control system to improve overall performance of a craft, for example an aircraft, especially a missile or torpedo.

To accomplish this, a method of control is implemented by use of a control routine which, although derived in generic form, is here demonstrated by a specific example. The craft of the present invention incorporates the appropriate hardware components and systems to implement, in combination with the necessary software, the control routines according to the present invention. While the example of the routine given involves a constant speed, of course the present invention includes routines involving variable speeds.

The term “inter-linked” control refers to a system whereby the wing and tail control surfaces are operated to move relative to each other to effect a manoeuvre of the airframe, while simultaneously offsetting the body axis relative to the instantaneous flight path velocity vector.

The method of control proposes that, in any actuation of the wing and tail, the craft (or missile) essentially exhibits an applied manoeuvre about an instantaneous zero lift line (ZLL). This feature, and the benefits it affords over conventional flight of craft, for example aircraft or missiles, is a major beneficial consequence of the present invention. There are also consequential benefits for weapon control systems which utilise missiles of the present invention.

FIG. 1A shows schematically a conventional missile 1 with a fixed wing 2 and a fully moving tail 3. Missile 1 manoeuvres by rotating the body axis relative to the flight path using aft tail control surface 3.

FIG. 2A shows schematically missile 1 as it manoeuvres primarily due to body angle of attack showing a grazing incidence at impact.

FIGS. 1B, 2B, and 3B show corresponding situations but for a missile 11 embodying a control system 20 of the present invention having a moving wing 12 with a link to control a moving tail 13, incorporating hardware components 21 and linkage system 22 with associated software 23 all of which implement the control routines of the present invention. Missile 11 manoeuvres relative to the zero lift line (ZLL) by rotation of both wing and tail surfaces. ZLL is selectable based on airframe aerodynamics to achieve improved missile look angle on target while maintaining appropriate manoeuvre. Missile 11 is subject to reduced manoeuvre stall limit over the conventional missile 1 above.

FIG. 2B shows a manoeuvre achieved by combined deflection of wing 12 and tail 13 at zero angle of attack which provides no grazing incidence at impact.

FIG. 3B indicates the benefits of the present invention over the situation shown in FIG. 3A of a conventional missile 1, whereby missile 11 provides a shorter acquisition range, a better shaped trajectory, potential to improve target top attack (by an improved potential to kill the target), better maintaining target lock-on throughout flight, and better acquisition of targets whether fixed or moving.

In FIG. 3B, the body altitude/ZLL of missile 11 is selected to maintain target lock-on throughout flight while maintaining trajectory manoeuvre.

FIG. 4B shows that missile 11 achieves the same low g manoeuvre with an improved look angle onto target 4, although the absolute manoeuvre g is stall-limited at a lower level.

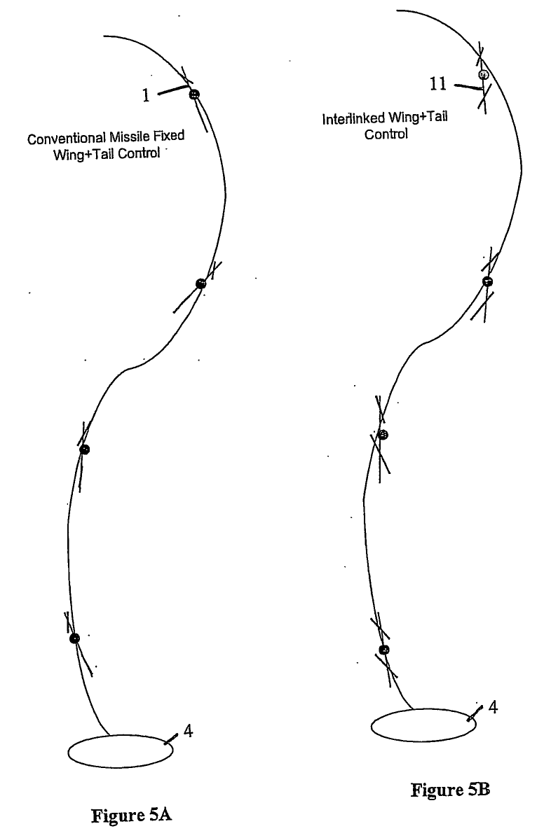

FIG. 5A shows the trajectory of missile 1 in an anti-ship implementation as it approaches target 4, involving a significant variation in Radar Cross-Section (RCS), this being typical of conventional missile 1.

In FIG. 5B, there is shown an RCS remaining reasonably steady even during manoeuvre to produce a confusing trajectory RCS return.

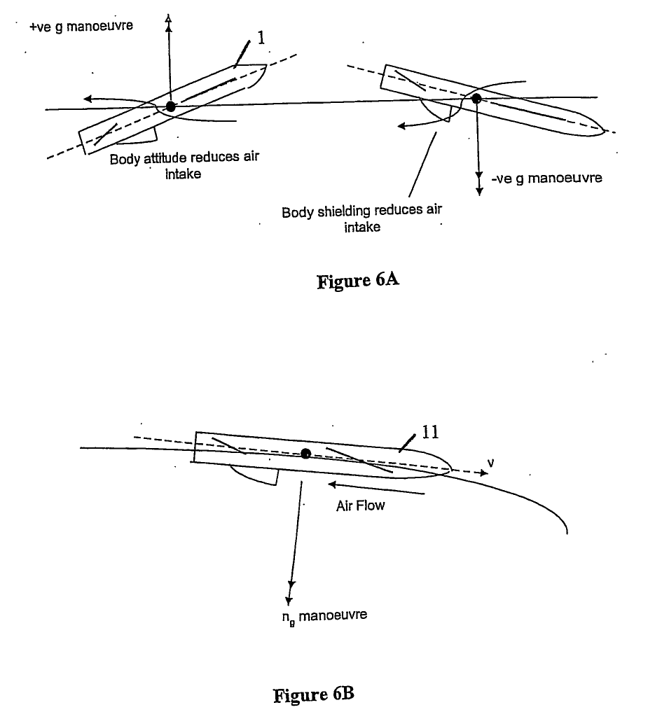

FIG. 6B indicates that the present invention allows missile 11 to manoeuvre with air intake in line with air flow, providing enhanced efficiency of fuel consumption, allowing increased range or less fuel for a given distance optionally allowing increased pay load.

FIG. 7 is a detailed schematic diagram of the terminal engagement trajectory of missile 11 including an initial pull-up, followed by a bunt manoeuvre down to the target. Prior to target acquisition (i.e. the locking of the missile on to the target), it is assumed that the attacking missile uses its seeker equipment to establish its own ground speed and cruise height and then processes the returns from the target to identify target speed and direction.

The initial pull-up manoeuvre starts at point “A” with the attacking missile assumed beginning the pull-up phase at a steady cruise height above ground level with the seeker equipment locked onto the target. For this example, it is assumed that both the attacking missile and the target are travelling in the plane of manoeuvre i.e. the pitch plane.

FIG. 8 illustrates what occurs in conventional missiles with fixed-wing and moving tail control surfaces whereby the pull-up phase risks losing lock with the target as the demand manoeuvre forces the missile seeker towards look-angle limits as the airframe puts on angle of attack.

This is particularly a risk with the target moving towards the attacking missile as the closing speed increases. To remedy this, a shallower trajectory may be initiated which, while offering reduced exposure to counterattack at altitude, reduces the impact angle with the target due to limited manoeuvre response time in completing the bunt.

This in turn limits warhead effectiveness, as the attitude at target intercept tends to be shallow. It also follows that, if the missile is still manoeuvring at target impact, then the airframe must put on incidence. This in turn implies that the missile grazing incidence will potentially be high, again limiting warhead effectiveness. Breaking away from the bunt manoeuvre during descent to the target allows the airframe to reduce grazing incidence at target impact, but at the expense of acquisition range prior to target lock-on.

This in turn either reduces the time available to process data to confirm the target as a threat prior to “lock-on”, or again forces subsequent bunt manoeuvre (post “lock-on”) to be shallow, due to reduced time of flight to impact the target.

To counter limitations posed by the conventional fixed-wing moving-tail missile, the present invention provides a moving wing and tail combination by an inter-linked (geared) electronic actuation control mechanism (see FIG. 9).

Latax manoeuvre may be achieved by deflecting the wing and tail relative to the missile body centreline in order that the line of zero lift acts off of the missile axis.

Manoeuvre is then initiated relative to this line. In the “pull-up” phase, this enables the body to fly with negative body axis incidence but with the combined wing and tail deflection offering positive relative angle of attack to the flight vector to provide the required manoeuvre g.

In this configuration, the manoeuvre is maintained but with a reduced “look-angle” to the target. Clearly this offers a reduced risk of the sightline hitting stops during pull-up which would otherwise result in loss of target “lock-on”.

This method of control affords additional flexibility to ensure greater freedom to shape the terminal bunt trajectory. At the apogee of the bunt manoeuvre, it may be advantageous to resort to similar control methods as those of the fixed wing design, since increased negative angle of attack to achieve positive manoeuvre g ensures that the look angle is reduced onto the target (note the convention here for +ve manoeuvre g in FIGS. 8 and 9 in particular).

However, during the descent phase, it is of major benefit to manoeuvre without pulling incidence, particularly in the last few seconds of flight.

Achieving this down to the target means that impact can be achieved with zero grazing incidence, thus ensuring optimal warhead efficiency. It further follows that the target impact angle will naturally be lower to the vertical again enhancing warhead efficiency. It should be noted in FIG. 9 that in addition to the zero lift line and associated angle, there is an additional incidence. This represents the more general case of incidence error in achieving an absolute Zero Lift Angle relative to the velocity vector along the flight path. Ideally, this “alpha” error is driven to zero in achieving the present invention and its inclusion in FIG. 9 is to present the more general case rather than the absolute ideal.

The detailed implementation provides the aforementioned benefits of the present invention including trajectory shaping and maintained look angle on the target, with the consequential advantages of optimising target impact warhead effectiveness.

The implementation encapsulates the generic trajectory shape in FIG. 7 formulated via a series of defining geometric parameters. This generic or idealistic trajectory shape comprises two arcs of a circle, with interface at the point where the trajectory leaves the “pull-up” phase and enters the terminal bunt. Throughout flight the missile is controlled to maintain constant speed V so that, despite continuity of climb angle at the interface of the two phases of flight, there is a step change in manoeuvre g from −ve in the “pull-up” to +ve in the bunt.

Two types of target are considered: fixed and moving. For a fixed target at “T0”, the attacking missile is assumed able to acquire the target beyond point “A”. With the target confirmed and “lock-on” achieved before point “A”, the missile travelling at constant speed “V” enters the terminal engagement trajectory by performing a pull-up manoeuvre at constant climb rate (constant radius of turn). At some point into climb “C”, the engagement algorithm signals that the airframe requires “limit manoeuvre g” to intercept the target. If the airframe subsequently executes a circular arc to intercept the target, the flight vector is at zero degrees to the vertical if the instantaneous centre of rotation in the bunt (point “O”) rests on the ground line coincident with the target. If the target is moving towards the attacking missile then it follows that, if “limit manoeuvre g” is not to be exceeded in intercepting at a biased and fixed aim point ahead of the target, the missile must leave the “pull-up” phase earlier than for the fixed target i.e. at point “M0”.

In this case, however, because the missile must not exceed “limit manoeuvre g”, the instantaneous centre of rotation must be at a point close to “OT3”, off the ground line.

Clearly the choice of points “M0” and the instantaneous point of rotation varies with speed of the target for the limit manoeuvre g, and must ensure that the time of flight from “A” to intercept the target coincides with the time the target takes to travel from “T0” to intercept. The target is locked onto at A. At this point, the target is T0. By the time the missile has flown the trajectory path i.e. pull up and pull down (bunt) the target will have travelled from T0 to meet up with the missile i.e. the two achieve intercept. In this case, it follows that the flight path vector at impact is greater than zero degrees angle to vertical. If it is assumed that the missile breaks away from the pull-up phase at point “M0” to intercept a fixed target at “T0” (trajectory T0′) “manoeuvre g” will be below the “limit manoeuvre g” for the airframe.

From FIG. 7 it also follows that if the missile breaks away from the pull-up phase at point “M0” with a turning circle equal to that required to intercept a fixed target at “T0”, and the radius of turn is progressively reduced by migrating the instantaneous centre of rotation along the line “OT′-OT3′” (such that the radius from the attacking missile to the instantaneous centre of rotation is equal to the radius from the instantaneous centre of rotation to the target), the missile will progress an arc through radii R1, R2, R3 etc at positions M1, M2, and M3 down to intercept with increasing manoeuvre g.

Note here that the loci of the instantaneous centres of rotation lie on the extended radius through the missile location at the time of breakaway from the pull-up manoeuvre. Throughout the subsequent trajectory, the “instantaneous manoeuvre g” is assumed to act normal to the flight path along the instantaneous radius with the constant velocity normal to this radius.

The instantaneous sightline is then the angle between the normal to the radius and the chord of the arc of the instantaneous manoeuvre circle between the missile and target for zero angle of attack.

The steady State Trim Condition

The benefits of the present invention may be summarised via analysis of the simple steady state trim condition for the present invention and conventional systems.

The Conventional Missile with a Fixed Wing+Moving Tail System

Taking moments about the instantaneous C of G,
Cm_{cg}=Cm_{cg}_{_{α}}.δ+Cm_{cg}_{_{δt}}.δₜ 1

For the Normal Force Coefficient in body fixed axes,
C_{N}=C_{N}_{_{α}}.α+C_{N}_{_{δt}}.δₜ 2

For a missile in instantaneous trim [Cmcg=0] with mass m, speed V, the trim incidence cc and tail control deflection δt are derived as follows

$$\begin{matrix}α = [ \frac{m . n {.}_{g} . g}{\frac{1}{2} ρ {V}^{2} S} ] \cdot [ \frac{{Cm}_{{cg}_{\partial }}}{( {C}_{{N}_{α}} . {Cm}_{{cg}_{\partial }} - {C}_{{N}_{\partial }} . {Cm}_{{cg}_{α}} )} ] \\ \text{and} , & 3 \\ {δ}_{t} = - [ \frac{m . n {.}_{g} . g}{\frac{1}{2} ρ {V}^{2} S} ] \cdot [ \frac{{Cm}_{{cg}_{α}}}{( {C}_{{N}_{α}} . {Cm}_{{cg}_{\partial }} - {C}_{{N}_{\partial }} . {Cm}_{{cg}_{α}} )} ] & 4\end{matrix}$$

Clearly from the first of these two equations demanding a manoeuvre requires angle of attack and this determines the tail deflection required to achieve it at the associated instantaneous trim state.

The Method of Control of the present invention e.g. with an Interlinked Wing+Tail

Taking moments about the instantaneous C of G,
Cm_{cg}=Cm_{cg}_{_{α}}.α+Cm_{cg}_{_{δw}}.δ_{w}+Cm_{cg}_{_{δt}}.δ 5

For the Normal Force Coefficient in body fixed axes,
C_{N}=C_{N}_{_{α}}.α+C_{N}_{_{δw}}.δ_{w}+C_{N}_{_{δt}}.δₜ 6

For conditions along the zero lift line (ZLL) Cm_{cg}=0 and C_{N}=0, α=α₀, δ_{W}=δ_{W0} and δₜ=δₜ₀, thus

$$[ \begin{matrix}{Cm}_{{cg}_{{δ}_{w}}} & {Cm}_{{cg}_{{δ}_{t}}} \\ {C}_{{N}_{{δ}_{{w}^{′}}}} & {C}_{{N}_{{δ}_{t}}}\end{matrix} ] \cdot [ \begin{matrix}{δ}_{{w}_{0}} \\ {δ}_{{t}_{0}}\end{matrix} ] = - [ \begin{matrix}{Cm}_{{cg}_{α}} \\ {C}_{{N}_{α}}\end{matrix} ] . {α}_{0} \qquad 7$$

or after solution,

$$[ \begin{matrix}{δ}_{{w}_{0}} \\ {δ}_{{t}_{0}}\end{matrix} ] = [ \begin{matrix}{Cm}_{{cg}_{{δ}_{t}}} . {C}_{{N}_{α}} - {C}_{{N}_{{δ}_{t}}} . {Cm}_{{cg}_{α}} \\ {C}_{{N}_{{δ}_{w}}} . {C}_{{m}_{{cg}_{α}}} - {C}_{{{m}_{cg}}_{{δ}_{w}}} . {C}_{{N}_{α}}\end{matrix} ] . {α}_{0} = [ \begin{matrix}{F}_{1} \\ {F}_{2}\end{matrix} ] . {α}_{0} \qquad 8$$

Note here that KGw₀ (the ratio of tail to wing control deflection at zero lift) is defined as,

$${KG}_{{w}_{0}} = \frac{{F}_{2}}{{F}_{1}} = \frac{{δ}_{{t}_{0}}}{{δ}_{{w}_{0}}} \qquad 9$$

If one changes to wind axes,
Cm_{cg}=Cm_{cg}_{_{α}}.(α−α₀)+Cm_{cg}_{_{δw}}.(δ_{w}−δ_{w}_{₀})+Cm_{cg}_{_{δt}}.(δₜ−δₜ_{₀}) 10
and,
C_{N}=C_{N}_{_{α}}.(α−α₀)+C_{N}_{_{δw}}.(δ_{w}−δ_{w}_{₀})+C_{N}_{_{δt}}.(δₜ−δₜ_{₀}) 11

It is assumed that the zero lift angle from the missile is sufficiently small that the normal force coefficient acting along the normal to the ZLL differs little from that acting normal to the missile body centreline.

Consider now all three angles to change relative to the conditions for zero lift i.e., for body angle of attack, α→α₀+α′, δw→δw₀+δw′ and δt→δt₀+δt′ after substitution,
Cm_{cg}=Cm_{cg}_{_{α}}.α′+Cm_{cg}_{_{δw}}.δ_{w}+Cm_{cg}_{_{δt}}.δₜ′ 12
and
C_{N}=C_{N}_{_{α}}.α′+C_{N}_{_{δw}}.δ′_{w}+C_{N}_{_{δt}}.δ′ₜ 13

Again in the trim state, Cm_{cg}=0 but under a demand manoeuvre, C_{N}≠0 and we find that,

$$\begin{matrix}{δ}_{t}^{′} = - \frac{( {Cm}_{{cg}_{α}} . {α}^{′} + {Cm}_{{cg}_{{δ}_{w}}} . {δ}_{w}^{′} )}{{Cm}_{{cg}_{{δ}_{t}}}} \\ and , & 14 \\ \begin{matrix}{C}_{N} = \frac{m . {n}_{g} . g}{( \frac{1}{2} . ρ . {V}^{2} . S )} \\ = \frac{\begin{matrix}⌊ {C}_{{N}_{α}} . {Cm}_{{cg}_{{δ}_{t}}} - {C}_{{N}_{{δ}_{t}}} . {Cm}_{{cg}_{α}} ⌋ . {α}^{′} + \\ ⌊ {C}_{{N}_{{δ}_{w}}} . {Cm}_{{cg}_{{δ}_{t}}} - {C}_{{N}_{{δ}_{t}}} . {Cm}_{{cg}_{{w}^{′}}} ⌋ . {δ}_{w}^{′}\end{matrix}}{{Cm}_{{cg}_{{δ}_{t}}}}\end{matrix} \\ {α}^{′} = 0 to yield , & 15 \\ \begin{matrix}{δ}_{t}^{′} = - ( \frac{{Cm}_{{cg}_{{δ}_{w}}}}{{Cm}_{{cg}_{{δ}_{t}}}} ) . {δ}_{w}^{′} \\ = {KG}_{w} . {δ}_{w}^{′} , \\ {KG}_{w} = - ( \frac{{Cm}_{{cg}_{{δ}_{w}}}}{{Cm}_{{cg}_{{δ}_{t}}}} ) ≻ 0\end{matrix} & 16\end{matrix}$$

In setting α′=0, it is assumed that the missile is controlled to achieve an incidence α₀. This is a by-product of the inter-linked control system employed. In reality the existence of α′ surfaces due to errors in achieving α₀ under natural control via the guidance and control loop.

With the assumption of the ideal case α′=0 it then follows that,

$$\begin{matrix}{δ}_{w} = {δ}_{{w}_{0}} + {δ}_{w}^{′} = {F}_{1} . {α}_{0} + \frac{( \frac{m . n {.}_{g} . g}{\frac{1}{2} ρ . {V}^{2} S} ) . {Cm}_{{cg}_{δ}}}{( {C}_{{N}_{δ}} . {Cm}_{{cg}_{\partial }} - {C}_{{N}_{\partial }} . {Cm}_{{cg}_{α}} )} & 17 \\ {δ}_{t} = {δ}_{{t}_{0}} + {δ}_{t}^{′} = {F}_{2} . {α}_{0} + {KG}_{w} \cdot [ \frac{( \frac{m . n {.}_{g} . g}{\frac{1}{2} ρ . {V}^{2} S} ) . {Cm}_{{cg}_{δ}}}{( {C}_{{N}_{δ r}} . {Cm}_{{cg}_{\partial }} - {C}_{{N}_{\partial }} . {Cm}_{{cg}_{δ w}} )} ] & 18\end{matrix}$$

Note the important point here that manoeuvre can be achieved by moving the wing and tail either with or without incidence α₀.

Simplifying these expressions,
δ_{w}=F₁α₀+K.n_{g} 19
and,
δₜ=F₂α₀+KG_{w}.K.n_{g} 20
where,

$$K = \frac{( \frac{m . n {.}_{g} . g}{\frac{1}{2} ρ . {V}^{2} S} ) . {Cm}_{{cg}_{δ}}}{( {C}_{{N}_{δ w}} . {Cm}_{{cg}_{\partial }} - {C}_{{N}_{\partial }} . {Cm}_{{cg}_{δ w}} )} \qquad 21$$

Rearranging,

$${KG}_{{w}_{0}} = \frac{{F}_{2} {α}_{0}}{{F}_{1} {α}_{0}} = \frac{{F}_{2}}{{F}_{1}} = \frac{{δ}_{t} - {KG}_{w} . K . {n}_{g}}{{δ}_{w} - K . {n}_{g}} \qquad 22$$

and hence,

$$\begin{matrix}{n}_{g} = \frac{( {KG}_{{w}_{0}} . {δ}_{w} - {δ}_{t} )}{( {KG}_{{w}_{0}} - {KG}_{w} ) . K} = {δ}_{w} \frac{( {KG}_{{w}_{0}} - {KG}_{w}^{′} )}{( {KG}_{{w}_{0}} - {KG}_{w} ) . K} \\ where , & 23 \\ {KG}_{w}^{′} = \frac{{δ}_{t}}{{δ}_{w}} = ( \frac{{KG}_{{w}_{0}} - {KG}_{w} . τ}{1 + τ} ) , τ = \frac{{δ}_{w}^{′}}{{δ}_{{w}_{0}}} = ( \frac{{δ}_{w} - {δ}_{{w}_{0}}}{{δ}_{{w}_{0}}} ) & 24\end{matrix}$$

Thus if δ′_{w}=0, τ=0 and KG_{W}′=KG_{w0} which implies a default to the zero lift line (ZLL) where the manoeuvre g is zero. This checks since in this case, substituting for KG_{w}′=KG_{w0} sets n_{g}=0.

After substitution and rearrangement,

$${n}_{g} = \frac{{δ}_{w}^{′}}{K} \qquad 25$$

which again confirms the same result that n_{g}=0 when δ′_{w}=0.

From a control point of view, it is more useful to use full wing control deflection and that associated with zero lift conditions, therefore the more appropriate form of expression for n_{g} is,

$${n}_{g} = \frac{( {δ}_{w} - {δ}_{w 0} )}{K} \qquad 26$$

Note that the choice of ZLL angle is arbitrary being restricted only by the stall condition primarily on the wing but also the tail. This lends itself to the possibility of demanding an effective ZLL angle which complies with sightline look angle limits while satisfying manoeuvre g requirements and lifting surface stall angle limitations.

Definition of Terminal Engagement Routine to negotiate both Fixed and Moving Targets.

Mathematical Analysis—Defining The Generic Engagement Routine

The terminal engagement trajectory is assumed comprised of two phases, a pull-up phase and a bunt phase.

In order to progress mathematical definition of the routine the schematic lo form of the terminal engagement trajectory in FIG. 10 is adopted and introduce necessary axis conventions and terminology that will be adopted throughout the ensuing analysis

Trajectory Kinematics-PULL-UP Phase

Transformation matrices defined in APPENDIX 1 are used throughout the ensuing analysis and are based on the conventions defined in FIG. 10.

Applying kinematic modelling of the missile using the axes convention of FIG. 10, the following matrix relationships between velocities and accelerations defined in rotating axes with instantaneous centre of rotation O_{c} at radius r_{cp} and those in instantaneous trajectory axes are as follows.

$$\begin{matrix}{\underline{v}}_{cp} = [ \begin{matrix}{\dot{r}}_{cp} & {r}_{cp} \cdot {\dot{θ}}_{cp}\end{matrix} ] [ \begin{matrix}Sin ( {θ}_{cp} ) & - Cos ( {θ}_{cp} ) \\ Cos ( {θ}_{cp} ) & Sin ( {θ}_{cp} )\end{matrix} ] \cdot [ \begin{matrix}Cos ( {θ}_{c} ) & Sin ( {θ}_{c} ) \\ Sin ( {θ}_{c} ) & - Cos ( {θ}_{c} )\end{matrix} ] \cdot [ \begin{matrix}{\underline{i}}_{traj} \\ {\underline{k}}_{traj}\end{matrix} ] & 27 \\ {\dot{\underline{v}}}_{cp} = [ ( {\underline{\ddot{r}}}_{cp} - {r}_{cp} \cdot {\dot{θ}}_{cp}^{2} ) \frac{1}{{r}_{cp}} \frac{\partial }{\partial t} [ {r}_{cp}^{2} \cdot {\dot{θ}}_{cp} ] ] \cdot [ \begin{matrix}Sin ( {θ}_{c} ) & - Cos ( {θ}_{c} ) \\ Cos ( {θ}_{c} ) & Sin ( {θ}_{c} )\end{matrix} ] \cdot [ \begin{matrix}Cos ( {θ}_{c} ) & Sin ( {θ}_{c} ) \\ Sin ( {θ}_{c} ) & - Cos ( {θ}_{c} )\end{matrix} ] \cdot [ \begin{matrix}{\underline{i}}_{traj} \\ {\underline{k}}_{traj}\end{matrix} ] \\ Hence , & 28 \\ [ \begin{matrix}{\underline{v}}_{cp} \\ {\underline{\dot{v}}}_{cp}\end{matrix} ] = [ \begin{matrix}{\dot{r}}_{cp} \cdot Sin ( {θ}_{cp} - {θ}_{c} ) + {r}_{cp} {\dot{θ}}_{cp} \cdot Cos ( {θ}_{cp} - {θ}_{c} ) & {\dot{r}}_{cp} \cdot Cos ( {θ}_{cp} - {θ}_{c} ) - {r}_{cp} {\dot{θ}}_{cp} \cdot Sin ( {θ}_{cp} - {θ}_{c} ) \\ ( {\ddot{r}}_{cp} - {r}_{cp} {\dot{θ}}_{cp}^{2} ) \cdot Sin ( {θ}_{cp} - {θ}_{c} ) + \frac{1}{{r}_{cp}} \cdot \frac{\partial }{\partial t} [ {r}_{cp}^{2} {\dot{θ}}_{cp} ] Cos ( {θ}_{cp} - {θ}_{c} ) & ( {\ddot{r}}_{cp} - {r}_{cp} {\dot{θ}}_{cp}^{2} ) \cdot Cos ( {θ}_{cp} - {θ}_{c} ) - \frac{1}{{r}_{cp}} \cdot \frac{\partial }{\partial t} [ {r}_{cp}^{2} {\dot{θ}}_{cp} ] Sin ( {θ}_{cp} - {θ}_{c} )\end{matrix} ] [ \begin{matrix}{\underline{i}}_{traj} \\ {\underline{k}}_{traj}\end{matrix} ] & 29\end{matrix}$$

$$[ \begin{matrix}{\underline{v}}_{cp} \\ {\underline{\dot{v}}}_{cp}\end{matrix} ] = [ \begin{matrix}\underline{v} \\ \dot{\underline{v}}\end{matrix} ] \qquad ( 30 )$$

Trajectory Kinematics-bunt Phase

Referring to FIG. 10, the following position vector relationships are derived,
rₒ_{_{T}}′+r′=r₁ 31
−r′+r_{T}=r_{SL} 32
rₒ_{_{T}}+r_{T}=r₁+rₛₗ=X_{T}(t*+t). i 33
(r_{cp}_{₀}+h_cruise)k⁻+r_{cp}·i_{cp}+r′kₜᵣₐⱼ=rₒ_{_{T}}′=rₒ_{_{T}}′iₒ_{_{T}}′ 34

Where,
rₒ_{_{T}}′=rₒ_{_{T}}′iₒ_{_{T}}′, r′=r′i′, r₁=r₁·i₁, r_{T}=r_{T}·i_{T}, rₛₗ=rₛₗ·iₛₗ 35

If t* is the time into flight at initiation of the pull-up manoeuvre and t is the time thereafter into the terminal phase trajectory then X_{T}(t*+t), the distance to target impact into the terminal trajectory from commencement of pull-up is given by,

$${X}_{T} ( {t}^{*} + t ) = {X}_{{T}_{0}} ( {t}^{*} ) + {\int }_{{t}^{*}}^{{t}^{*} + t} {V}_{T} \cdot ⅆ t - {\int }_{{t}^{*}}^{{t}^{*} + t} \frac{\partial }{\partial t} {X}_{E} ( t ) \cdot \partial t \qquad ( 36 )$$

Where V_{T}<0 if the target is moving towards the attacking missile, V_{T}>0 if moving away and V_{T}=0 if stationary. X_{E}(t) is the ground range covered by the attacking missile after t secs into flight post entry into the terminal engagement manoeuvre.

If rₛₗ*, is the sightline range at target lock-on entering the terminal engagement trajectory then it also follows that,
x_{T}_{₀}(t*)=\sqrt{(rₛₗ*²−h_cruise²)} 37
where,
rₛₗ*=rₛₗ(t*) 38

For the instantaneous centre of rotation at OT′, differentiating yields,

$$\begin{matrix}{\underline{V}}_{{o}_{T}^{′}} = {\dot{\underline{r}}}_{{o}_{T}^{′}} \\ = {\dot{r}}_{{o}_{T}^{′}} . {\underline{i}}_{{o}_{T}^{′}} + {r}_{{o}_{T}^{′}} \cdot \frac{\partial {\underline{i}}_{{o}_{T}^{′}}}{\partial t} \\ = {\dot{r}}_{{o}_{T}^{′}} \cdot {\underline{i}}_{{o}_{T}^{′}} + {r}_{{o}_{T}^{′}} \cdot \frac{\partial {\underline{i}}_{{o}_{T}^{′}}}{\partial {θ}_{{o}_{T}^{′}}} \cdot \frac{\partial {θ}_{{o}_{T}^{′}}}{\partial t} \\ = {\dot{r}}_{{o}_{T}^{′}} \cdot {\underline{i}}_{{o}_{T}^{′}} + {r}_{{o}_{T}^{′}} \cdot {\dot{θ}}_{{o}_{T}^{′}} \cdot {\underline{k}}_{{o}_{T}^{′}}\end{matrix} \qquad ( 39 )$$

or in matrix form,

$$\begin{matrix}{\underline{V}}_{{o}_{T}^{′}} = [ {\dot{r}}_{{o}_{T}^{′}} {r}_{{o}_{T}^{′}} \cdot {\dot{θ}}_{{o}_{T}^{′}} ] \cdot [ \begin{matrix}{\underline{i}}_{{o}_{T}^{′}} \\ {\underline{k}}_{{o}_{T}^{′}}\end{matrix} ] \\ = [ {\dot{r}}_{{o}_{T}^{′}} {r}_{{o}_{T}^{′}} \cdot {\dot{θ}}_{{o}_{T}^{′}} ] [ \begin{matrix}Cos ( {θ}_{{o}_{T}^{′}} ) & - Sin ( {θ}_{{o}_{T}^{′}} ) \\ - Sin ( {θ}_{{o}_{T}^{′}} ) & - Cos ( {θ}_{{o}_{T}^{′}} )\end{matrix} ] \cdot [ \begin{matrix}\underline{i} \\ \overline{\underline{k}}\end{matrix} ] \\ = [ \{ \begin{matrix}{\dot{r}}_{{o}_{T}^{′}} \cdot Cos ( {θ}_{{o}_{T}^{′}} ) - \\ {r}_{{o}_{T}^{′}} \cdot {\dot{θ}}_{{o}_{T}^{′}} \cdot Sin ( {θ}_{{o}_{T}^{′}} )\end{matrix} \} - \{ \begin{matrix}{\dot{r}}_{{o}_{T}^{′}} \cdot Sin ( {θ}_{{o}_{T}^{′}} ) + \\ {r}_{{o}_{T}^{′}} \cdot {\dot{θ}}_{{o}_{T}^{′}} \cdot Cos ( {θ}_{{o}_{T}^{′}} )\end{matrix} \} ] [ \begin{matrix}\underline{i} \\ \overline{\underline{k}}\end{matrix} ]\end{matrix} \qquad ( 40 )$$

Differentiating equation 40 then yields the instantaneous centre of rotation acceleration vector to be,
\dot{V}ₒ_{_{T}}′=[{(\ddot{r}ₒ_{_{T}}′−rₒ_{_{T}}′\ddot{θ}ₒ_{_{T}}′².).Cos(θₒ_{_{T}}′)−(rₒ_{_{T}}′\ddot{θ}ₒ_{_{T}}′+2{dot over (rₒ_{_{T}})}′\dot{θ}ₒ_{_{T}}′)SIn(θₒ_{_{T}}′)}i−{(\ddot{r}ₒ_{_{T}}′−rₒ_{_{T}}′\dot{θ}ₒ_{_{T}}′².)Sin(θₒ_{_{T}}′)+(rₒ_{_{T}}′\ddot{θ}ₒ_{_{T}}′=2\dot{r}ₒ_{_{T}}′\dot{θ}ₒ_{_{T}}′)Cos(θₒ_{_{T}}′)}k⁻] 41

For the target the velocity vector V_{T} is given by,

$$\begin{matrix}{\underline{V}}_{T} = {\underline{\dot{r}}}_{T} + {\underline{V}}_{{o}_{T}^{′}} \\ = {\dot{r}}_{T} \cdot {\underline{i}}_{T} + {r}_{T} \cdot \frac{\partial {\underline{i}}_{T}}{\partial t} + {\underline{V}}_{{o}_{T}^{′}} \\ = {\dot{r}}_{T} \cdot {\underline{i}}_{T} + {r}_{T} \cdot \frac{\partial {\underline{i}}_{T}}{\partial {θ}_{{L}^{′}}} \cdot \frac{\partial {θ}_{{L}^{′}}}{\partial t} + {\underline{V}}_{{o}_{T}^{′}} \\ = {\dot{r}}_{T} \cdot {\underline{i}}_{T} - {r}_{T} \cdot {\dot{θ}}_{{L}^{′}} \cdot {\underline{k}}_{T} + {\underline{V}}_{{o}_{T}^{′}}\end{matrix} \qquad ( 42 )$$

From equation 42,

$$\begin{matrix}{\underline{V}}_{T} = [ {\dot{r}}_{T} - {r}_{T} \cdot {\dot{θ}}_{L}^{′} ] [ \begin{matrix}{\underline{i}}_{T} \\ {\underline{k}}_{T}\end{matrix} ] + {\underline{V}}_{{o}_{T}^{′}} \\ = [ {\dot{r}}_{T} - {r}_{T} \cdot {\dot{θ}}_{{L}^{′}} ] [ \begin{matrix}Cos ( {θ}_{L} ) & Sin ( {θ}_{L} ) \\ Sin ( {θ}_{L} ) & - Cos ( {θ}_{L} )\end{matrix} ] [ \begin{matrix}\underline{i} \\ \overline{\underline{k}}\end{matrix} ] + {\underline{V}}_{{o}_{T}^{′}} \\ = [ \{ \begin{matrix}{\dot{r}}_{T} \cdot Cos ( {θ}_{L} ) - \\ {r}_{T} \cdot {\dot{θ}}_{{L}^{′}} \cdot Sin ( {θ}_{{L}^{′}} )\end{matrix} \} \{ \begin{matrix}{\dot{r}}_{T} \cdot Sin ( {θ}_{{L}^{′}} ) + \\ {r}_{T} \cdot {\dot{θ}}_{{L}^{′}} Cos ( {θ}_{{L}^{′}} )\end{matrix} \} ] [ \begin{matrix}\underline{i} \\ \underline{k}\end{matrix} ] + \\ [ \{ \begin{matrix}{\dot{r}}_{{o}_{T}^{′}} \cdot Cos ( {θ}_{{o}_{T}^{′}} ) - \\ {r}_{{o}_{T}^{′}} \cdot {\dot{θ}}_{{o}_{T}^{′}} \cdot Sin ( {θ}_{{o}_{T}^{′}} )\end{matrix} \} - \{ \begin{matrix}{\dot{r}}_{{o}_{T}^{′}} \cdot Sin ( {θ}_{{o}_{T}^{′}} ) + \\ {r}_{{o}_{T}^{′}} \cdot {\dot{θ}}_{{o}_{T}^{′}} \cdot Cos ( {θ}_{{o}_{T}^{′}} )\end{matrix} \} ] [ \begin{matrix}\underline{i} \\ \underline{k}\end{matrix} ] \\ = [ \{ \begin{matrix}{\dot{r}}_{T} \cdot Cos ( {θ}_{{L}^{′}} ) - \\ {r}_{T} \cdot {\dot{θ}}_{{L}^{′}} \cdot Sin ( {θ}_{{L}^{′}} ) + \\ {r}_{{o}_{T}^{′}} \cdot Cos ( {θ}_{{o}_{T}^{′}} ) - \\ {r}_{{o}_{T}^{′}} \cdot {\dot{θ}}_{{o}_{T}^{′}} \cdot Sin ( {θ}_{{o}_{T}^{′}} )\end{matrix} \} \{ \begin{matrix}{\dot{r}}_{T} \cdot Sin ( {θ}_{{L}^{′}} ) + \\ {r}_{T} \cdot {\dot{θ}}_{{L}^{′}} Cos ( {θ}_{{L}^{′}} ) - \\ {\dot{r}}_{{o}_{T}^{′}} \cdot Sin ( {θ}_{{o}_{T}^{′}} ) - \\ {r}_{{o}_{T}^{′}} \cdot {\dot{θ}}_{{o}_{T}^{′}} \cdot Cos ( {θ}_{{o}_{T}^{′}} )\end{matrix} \} ] [ \begin{matrix}\underline{i} \\ \underline{k}\end{matrix} ]\end{matrix} \qquad 43$$

Since the target is assumed to travel along the earth fixed x axis, it follows from applying the boundary condition at the ground that
{\dot{r}_{T}.Cos(θ_{L}′)−r_{T}.\dot{θ}_{L}′.Sin(θ_{L}′)+\dot{r}ₒ_{_{T}}′.Cos(θₒ_{_{T}}′)−rₒ_{_{T}}′.\dot{θ}ₒ_{_{T}}′)}=V_{T} 44
and,
\dot{r}_{T}Sin(θ_{L}′)+r_{T}.\dot{θ}._{L}′ Cos(θ_{L}′)−\dot{r}ₒ_{_{T}}′ Sin(θₒ_{_{T}}′)−rₒ_{_{T}}′.\dot{θ}ₒ_{_{T}}′.Cos(θₒ_{_{T}}′)=0 45
since no velocity normal to the surface exists.

Differentiating this expression and noting that ik is invariant under differentiation (fixed earth axis unit vectors) it follows that the acceleration of the target in earth axes is given by,
\dot{V}_{T}″[{(\ddot{r}_{T}−r_{T}\dot{θ}_{L}′²)Cos(θ′_{L})−(r_{T}\ddot{θ}_{L}′+2\dot{r}_{T}\dot{θ}_{L}′)Sin(θ′_{L})+(\ddot{r}ₒ_{_{T}}−rₒ_{_{T}}\dot{θ}ₒ_{_{T′}})Cos(Θₒ_{_{T′}})−(rₒ_{_{T′}}\ddot{θ}ₒ_{_{T′}}+2\dot{r}ₒ_{_{T′}}\dot{θ}ₒ_{_{T′}})Sin((θₒ_{_{T′}})}i+{(\ddot{r}_{T}−r_{T}\dot{θ}_{L}′²)Sin(θ′_{L})+(r_{T}\ddot{θ}_{L}′+2\dot{r}_{T}\dot{θ}_{L}′)Cos(θ′_{L})−(\ddot{r}ₒ_{_{T′}}−rₒ_{_{T′}}{dot over (θₒ_{_{T′}}²)})Sin(θₒ_{_{T′}})−(rₒ_{_{T′}}\ddot{θ}ₒ_{_{T′}}+2\dot{r}ₒ_{_{T′}}\dot{θ}ₒ_{_{T′}})Cos(θₒ_{_{T′}})}k⁻] 46

Again since acceleration along but not normal to the surface may exist it follows that,
{(\ddot{r}_{T}−r_{T}\dot{θ}_{L′}²)Cos(θ′_{L})−(r_{T}\ddot{θ}_{L}′+2\dot{r}_{T}\dot{θ}_{L}′)+(\ddot{r}ₒ_{_{T}}−rₒ_{_{T′}}\dot{θ}ₒ_{_{T′}}²)Cos(θₒ_{_{T′}})−(rₒ_{_{T′}}\ddot{θ}ₒ_{_{T′}}+2\dot{r}ₒ_{_{T′}}\dot{θ}ₒ_{_{T′}})Sin(θₒ_{_{T′}})}=\dot{V}_{T} 47
and,
{(\ddot{r}_{T}−r_{T}\dot{θ}_{L}′²)Sin(θ′_{L})+(r_{T}\ddot{θ}_{L}′+\dot{r}_{T}\dot{θ}_{L}′)Cos(θ′_{L})−(\ddot{r}ₒ_{_{T′}}−rₒ_{_{T′}}\dot{θ}ₒ_{_{T′}}²)Sin(θₒ_{_{T′}})−(rₒ_{_{T′}}\ddot{θ}ₒ_{_{T′}}+2\dot{r}ₒ_{_{T′}}\dot{θ}ₒ_{_{T′}})Cos(θₒ_{_{′}})}=0 48

From equation 32 the derivative is,

$$- \frac{\partial {\underline{r}}^{′}}{\partial t} + \frac{\partial {\underline{r}}_{T}}{\partial t} = \frac{\partial {\underline{r}}_{SL}}{\partial t} \qquad ( 49 )$$

.i.e. using velocity vector notation,
−V′+V_{T}=Vₛₗ 50

For the attacking missile the instantaneous velocity vector V′ and acceleration vector d V′/dt is then given by,

$$[ \begin{matrix}{V}^{′} \\ {\dot{V}}^{′}\end{matrix} ] = \\ [ \begin{matrix}{\dot{r}}^{′} Cos ( {θ}^{′} ) - {r}^{′} {\dot{θ}}^{′} \cdot Sin ( {θ}^{′} ) & {\dot{r}}^{′} \cdot Sin ( {θ}^{′} ) + {r}^{′} \dot{θ} \cdot Cos ( {θ}^{′} ) \\ ( {\ddot{r}}^{′} - {r}^{′} {\dot{θ}}^{′2} ) \cdot Cos ( {θ}^{′} ) - \frac{1}{{r}^{′}} \cdot \frac{\partial }{\partial t} [ {r}^{′2} {\dot{θ}}^{′} ] Sin ( {θ}^{′} ) & ( {\overline{r}}^{′} - {r}^{′} {\dot{θ}}^{′2} ) \cdot Sin ( {θ}^{′} ) + \frac{1}{{r}^{′}} \cdot \frac{\partial }{\partial t} [ {r}^{′2} {\dot{θ}}^{′} ] Cos ( {θ}^{′} )\end{matrix} ] \cdot [ \begin{matrix}\underline{i} \\ \underline{k} -\end{matrix} ] + [ \begin{matrix}{\underline{V}}_{{o}_{T}^{′}} \\ {\dot{\underline{V}}}_{{o}_{T}^{′}}\end{matrix} ] \qquad ( 51 )$$

Simplifying and converting totally into earth axes unit vectors yields,

$$\begin{matrix}{\underline{V}}^{′} = [ \begin{matrix}\{ {\dot{r}}^{′} Cos ( {θ}^{′} ) - {r}^{′} {\dot{θ}}^{′} \cdot Sin ( {θ}^{′} ) \} & \{ {\dot{r}}^{′} {\dot{θ}}^{′} \cdot Sin ( {θ}^{′} ) \}\end{matrix} ] [ \begin{matrix}\underline{i} \\ {\underline{k}}^{-}\end{matrix} ] + [ \begin{matrix}\{ {\dot{r}}_{{o}_{T}}^{′} \cdot Cos ( {θ}_{{o}_{T}^{′}} ) - {r}_{{O}_{T}^{′}} \cdot {\dot{θ}}_{{O}_{T}^{′}} \cdot Sin ( {θ}_{{o}_{T}^{′}} ) \} & - \{ {\dot{r}}_{{o}_{T}}^{′} \cdot Sin ( {θ}_{{o}_{T}^{′}} ) + {r}_{{O}_{T}^{′}} {\dot{θ}}_{{O}_{T}^{′}} \cdot Cos ( {θ}_{{o}_{T}^{′}} ) \}\end{matrix} ] [ \begin{matrix}\underline{i} \\ {\underline{k}}^{-}\end{matrix} ] = [ \begin{matrix}\{ {\dot{r}}^{′} Cos ( {θ}^{′} ) - {r}^{′} \dot{θ} Sin ( {θ}^{′} ) + {\dot{r}}_{{o}_{T}}^{′} \cdot Cos ( {θ}_{{o}_{T}^{′}} ) - {r}_{{O}_{T}^{′}} \cdot {\dot{θ}}_{{O}_{T}^{′}} \cdot Sin ( {θ}_{{o}_{T}^{′}} ) \} & \{ {\dot{r}}^{′} Sin ( {θ}^{′} ) + {r}^{′} \dot{θ} Cos ( {θ}^{′} ) - {\dot{r}}_{{o}_{T}}^{′} \cdot Sin ( {θ}_{{o}_{T}^{′}} ) - {r}_{{O}_{T}^{′}} \cdot {\dot{θ}}_{{O}_{T}^{′}} \cdot Cos ( {θ}_{{o}_{T}^{′}} ) \}\end{matrix} ] [ \begin{matrix}\underline{i} \\ {\underline{k}}^{-}\end{matrix} ] & 52 \\ and , & \\ {\underline{\dot{V}}}^{′} = [ \{ ( {\ddot{r}}^{′} - {r}^{′} {\dot{θ}}^{′ 2} ) \cdot Cos ( {θ}^{′} ) - \frac{1}{{r}^{′}} \cdot \frac{\partial }{\partial t} [ \begin{matrix}{r}^{′ 2} & {\dot{θ}}^{′}\end{matrix} ] \cdot Sin ( {θ}^{′} ) + ( {\ddot{r}}_{{o}_{T}^{′}} - {r}_{{o}_{T}^{′}} {\dot{θ}}_{{o}_{T}^{′}}^{2} \cdot ) \cdot Cos ( {θ}_{{o}_{T}^{′}} ) - ( {r}_{{o}_{T}^{′}} {\ddot{θ}}_{{o}_{T}^{′}} + 2 {\dot{r}}_{{o}_{T}^{′}} {\dot{θ}}_{{o}_{T}^{′}} ) Sin ( {θ}_{{o}_{T}^{′}} ) \} \cdot \underline{i} + \{ ( {\ddot{r}}^{′} - {r}^{′} {\dot{θ}}^{′ 2} ) \cdot Sin ( {θ}^{′} ) + \frac{1}{{r}^{′}} \cdot \frac{\partial }{\partial t} [ \begin{matrix}{r}^{′ 2} & {\dot{θ}}^{′}\end{matrix} ] \cdot Cos ( {θ}^{′} ) - ( {\ddot{r}}_{{o}_{T}^{′}} - {r}_{{o}_{T}^{′}} {\dot{θ}}_{{o}_{T}^{′}}^{2} \cdot ) \cdot Sin ( {θ}_{{o}_{T}^{′}} ) - ( {r}_{{o}_{T}^{′}} {\ddot{θ}}_{{o}_{T}^{′}} + 2 {\dot{r}}_{{o}_{T}^{′}} {\dot{θ}}_{{o}_{T}^{′}} ) Cos ( {θ}_{{o}_{T}^{′}} ) \} \cdot {\underline{k}}^{-} ] & 53\end{matrix}$$

Combining equations 43, 50 and 52 defines the instantaneous sightline i5 angle, and subsequently sightline rate in missile body axes,

Sightline Angle and Rate

From FIG. 4, the unit vector in missile body fixed axes along the sightline to the target is given by,

$$\begin{matrix}{\underline{i}}_{sl} = \frac{{\underline{r}}_{sl}}{‖ {\underline{r}}_{sl} ‖} \\ = \frac{( {\underline{r}}_{T} - {\underline{r}}^{′} )}{‖ {\underline{r}}_{T} - {\underline{r}}^{′} ‖} \\ = \frac{[ \begin{matrix}( {r}_{T} \cdot Cos ( {θ}_{L}^{′} ) - {r}^{′} \cdot Cos ( {θ}^{′} ) ) & ( - {r}^{′} \cdot Sin ( {θ}^{′} ) + {r}_{T} \cdot Sin ( {θ}_{L}^{′} ) )\end{matrix} ] [ \begin{matrix}Cos ( {θ}_{c} + α ) & Sin ( {θ}_{c} + α ) \\ Sin ( {θ}_{c} + α ) & - Cos ( {θ}_{c} + α )\end{matrix} ] \cdot [ \begin{matrix}{\underline{i}}_{B} \\ {\underline{k}}_{B}\end{matrix} ]}{{r}_{sl}^{2}} \\ = \frac{[ \begin{matrix}( {r}_{T} \cdot Cos ( {θ}_{L}^{′} ) - {r}^{′} \cdot Cos ( {θ}^{′} ) ) & ( - {r}^{′} \cdot Sin ( {θ}^{′} ) + {r}_{T} \cdot Sin ( {θ}_{L}^{′} ) )\end{matrix} ] \cdot [ \begin{matrix}Cos ( θ ) & Sin ( θ ) \\ Sin ( θ ) & - Cos ( θ )\end{matrix} ] \cdot [ \begin{matrix}{\underline{i}}_{B} \\ {\underline{k}}_{B}\end{matrix} ]}{{r}_{sl}^{2}} \\ = \frac{[ \begin{matrix}( {r}_{T} \cdot Cos ( θ - {θ}_{L}^{′} ) - {r}^{′} \cdot Cos ( θ - {θ}^{′} ) ) & ( {r}_{T} \cdot Sin ( θ - {θ}_{L}^{′} ) - {r}^{′} \cdot Sin ( θ - {θ}^{′} ) )\end{matrix} ] \cdot [ \begin{matrix}{\underline{i}}_{B} \\ {\underline{k}}_{B}\end{matrix} ]}{{r}_{sl}^{2}}\end{matrix} \qquad 54$$

it then follows that,
Cos(γ,ₛₗ)=iₛₗ·i_{B} 55
where ‘●’ implies the vector dot product.

Whereupon,

$$\begin{matrix}Cos ( {γ}_{sl} ) = \frac{{r}_{T} \cdot Cos ( θ - {θ}_{L}^{′} ) - {r}^{′} \cdot Cos ( θ - {θ}^{′} )}{{[ {r}_{T}^{2} - 2 \cdot {r}_{T} \cdot {r}^{′} \cdot Cos ( {θ}^{′} - {θ}_{L}^{′} ) + {r}^{′ 2} ]}^{1 / 2}} & 56 \\ = \frac{{r}_{T} \cdot Cos ( θ - {θ}_{L}^{′} ) - {r}^{′} \cdot Cos ( θ - {θ}^{′} )}{{r}_{sl}} & \\ Sin ( {γ}_{sl} ) = \frac{{r}_{T} \cdot Sin ( θ - {θ}_{L}^{′} ) - {r}^{′} \cdot Sin ( θ - {θ}^{′} )}{{[ {r}_{T}^{2} - 2 \cdot {r}_{T} \cdot {r}^{′} \cdot Cos ( {θ}^{′} - {θ}_{L}^{′} ) + {r}^{′ 2} ]}^{1 / 2}} & 57 \\ = \frac{{r}_{T} \cdot Sin ( θ - {θ}_{L}^{′} ) - {r}^{′} \cdot Sin ( θ - {θ}^{′} )}{{r}_{sl}} & \\ or , & \\ \begin{matrix}{γ}_{sl} = {Tan}^{- 1} [ \frac{{r}_{T} \cdot Sin ( θ - {θ}_{L}^{′} ) - {r}^{′} \cdot Sin ( θ - {θ}^{′} )}{{r}_{T} \cdot Cos ( θ - {θ}_{L}^{′} ) - {r}^{′} \cdot Cos ( θ - {θ}^{′} )} ] & see Figure 5\end{matrix} & 58\end{matrix}$$

Note here that θ=(θ_{c}+α) where suffix ‘c’ implies ‘climb angle’ and α is the instantaneous angle of attack. θ′_{L} is as defined in FIG. 10 and in the limiting case at the point of impact determines, via the complement angle (π/2-θ′_{L}), the angle the flight vector makes with the vertical at impact

Differentiating the expression for sightline angle in equation 58 yields the sightline rate as follows,

$$\begin{matrix}{\dot{γ}}_{sl} = \frac{[ \begin{matrix}{r}_{T} {\dot{r}}^{′} \cdot Cos ( θ - α - {θ}_{L}^{′} ) + {r}_{T} {r}^{′} {\dot{θ}}^{′} \cdot Sin ( θ - α - {θ}_{L}^{′} ) - \\ {r}_{T}^{2} \cdot {\dot{θ}}_{L}^{′} - {r}^{′} {\dot{r}}^{′} \cdot Cos ( θ - {θ}^{′} - α ) - {r}^{′ 2} \dot{θ} \cdot Sin ( α - θ - {θ}^{′} ) - \\ {r}^{′} {\dot{r}}_{T} \cdot Sin ( {θ}^{′} - {θ}_{L}^{′} ) + {r}^{′} {r}_{T} {\dot{θ}}_{L}^{′} \cdot Cos ( {θ}^{′} - {θ}_{L}^{′} )\end{matrix} ]}{{r}_{sl}^{2}} + \dot{θ} & 59 \\ = \frac{[ \begin{matrix}{r}_{T} {\dot{r}}^{′} \cdot Sin ( {θ}^{′} - {θ}_{L}^{′} ) + {r}_{T} {r}^{′} \dot{θ} \cdot Cos ( {θ}^{′} - {θ}_{L}^{′} ) - {r}_{T}^{2} \cdot {\dot{θ}}_{L}^{′} - \\ {r}^{′ 2} {\dot{θ}}^{′} - {r}^{′} {\dot{r}}_{T} \cdot Sin ( {θ}^{′} - {θ}_{L}^{′} ) + {r}^{′} {r}_{T} {\dot{θ}}_{L}^{′} \cdot Cos ( {θ}^{′} - {θ}_{L}^{′} )\end{matrix} ]}{{r}_{sl}^{2}} + \dot{θ} & \\ Where , & \\ {r}_{sl}^{2} = [ {r}_{T}^{2} - 2 \cdot {r}_{T} \cdot {r}^{′} \cdot Cos ( {θ}^{′} - {θ}_{L}^{′} ) + {r}^{′ 2} ] & 60\end{matrix}$$

Note that for instantaneous motion in a circle about o_{T} ′ the substitution θ′=π/2+θ_{C} is made.

Generalised Manoeuvre Conditions during the Bunt Phase

If transform the kinematic equations for the attacking missile derived are lo transformed and in equations 51 and 52 into trajectory axes, and if assumed constant flight speed along the trajectory (V) with a manoeuvre g of n_{g} normal to the flight path,

For trajectory velocity V along the flight path,
−r′\dot{θ}+\dot{r}₀_{_{T}}′Sin(θ′+θ′)+r₀_{_{T}}′\dot{θ}₀_{_{T}}′.Cos(θ′+θ₀_{_{T}}′)=V 61
and for zero velocity normal to the flight path,
−\dot{r}′−\dot{r}₀_{_{T}}′.Cos(θ′+θ₀_{_{T}}′)+r₀_{_{T}}′\dot{θ}₀_{_{T}}′Sin(θ′+θ₀_{_{T}}′)=0 62

Similarly for trajectory acceleration/manoeuvre requirements it follows that if flight speed is constant along the trajectory then acceleration is zero hence,

$$- \frac{1}{{r}^{′}} \cdot \frac{\partial }{\partial t} [ {r}^{′ 2} \cdot {\dot{θ}}^{′} ] + ( {\ddot{r}}_{{0}_{T}}^{′} - {r}_{{0}_{T}}^{′} \cdot {\dot{θ}}_{{0}_{T}}^{′ 2} ) \cdot Sin ( {θ}^{′} + {θ}_{{0}_{T}}^{′} ) + \frac{1}{{r}_{{0}_{T}}^{′}} \cdot \frac{\partial }{\partial t} [ {r}_{{0}_{T}}^{′ 2} \cdot {\dot{θ}}_{{0}_{T}}^{′} ] Cos ( {θ}^{′} + {θ}_{{0}_{T}}^{′} ) = 0 \qquad 63$$

and for manoeuvre in an instantaneous arc at constant speed the instantaneous manoeuvre g normal to the flight path velocity vector acting towards the instantaneous centre of rotation is given by,

$$- ( {\ddot{r}}^{′} - {r}^{′} \cdot {\dot{θ}}^{2} ) - ( {\ddot{r}}_{{0}_{T}}^{′} - {r}_{{0}_{T}}^{′} \cdot {\dot{θ}}_{{0}_{T}}^{′ 2} ) \cdot Cos ( {θ}^{′} + {θ}_{{0}_{T}}^{′} ) + \frac{1}{{r}_{{0}_{T}}^{′}} \cdot \frac{\partial }{\partial t} [ {r}_{{0}_{T}}^{′ 2} \cdot {\dot{θ}}_{{0}_{T}}^{′} ] \cdot Sin ( {θ}^{′} + {θ}_{{0}_{T}}^{′} ) = {n}_{g} g \qquad 64$$

Rearranging these equations that the instantaneous velocity components for the instantaneous centre of rotation are given by,
\dot{r}₀_{_{T}}′=(V+r′.\dot{θ}′)Sin(θ′+θ₀_{_{T}}′−\dot{r}′.Cos(θ′+θ₀_{_{T}}′) 65
r₀_{_{T}}′\dot{θ}₀_{_{T}}′=(V+r′\dot{θ})Cos(θ′+θ₀_{_{T}}′)+\dot{r}′ Sin(θ′+θ₀_{_{T}}′) 66
and the associated instantaneous acceleration components are then defined as,

$$\begin{matrix}{\ddot{r}}_{{0}_{T}}^{′} - {r}_{{0}_{T}}^{′} \cdot {\dot{θ}}_{{0}_{T}}^{′ 2} = \frac{1}{{r}^{′}} \cdot \frac{\partial }{\partial t} [ {r}^{′ 2} \cdot {\dot{θ}}^{′} ] \cdot Sin ( {θ}^{′} + {θ}_{{0}_{T}}^{′} ) - [ {n}_{g} g + ( {\ddot{r}}^{′} - {r}^{′} \cdot {\dot{θ}}^{′ 2} ) ] \cdot Cos ( {θ}^{′} + {θ}_{{0}_{T}}^{′} ) & 67 \\ \frac{1}{{r}_{{0}_{T}}^{′}} \frac{\partial }{\partial t} [ {r}_{{0}_{T}}^{′ 2} \cdot {\dot{θ}}_{{0}_{T}}^{′} ] = \frac{1}{{r}^{′}} \frac{\partial }{\partial t} [ {r}^{′ 2} \cdot {\dot{θ}}^{′} ] \cdot Cos ( {θ}^{′} + {θ}_{{0}_{T}}^{′} ) + [ {n}_{g} g + ( {\ddot{r}}^{′} - {r}^{′} \cdot {\dot{θ}}^{′ 2} ) ] \cdot Sin ( {θ}^{′} + {θ}_{{0}_{T}}^{′} ) & 68\end{matrix}$$

(see FIG. 10)

For the target equations 44 and 45 in the matrix form,

$$\begin{matrix}[ \begin{matrix}Cos ( {θ}_{L}^{′} ) & - Sin ( {θ}_{L}^{′} ) \\ Sin ( {θ}_{L}^{′} ) & Cos ( {θ}_{L}^{′} )\end{matrix} ] \cdot [ \begin{matrix}{\dot{r}}_{T} \\ {r}_{T} \cdot {\dot{θ}}_{L}^{′}\end{matrix} ] + \\ [ \begin{matrix}Cos ( {θ}_{{0}_{T}}^{′} ) & - Sin ( {θ}_{{0}_{T}}^{′} ) \\ - Sin ( {θ}_{{0}_{T}}^{′} ) & - Cos ( {θ}_{{0}_{T}}^{′} )\end{matrix} ] \cdot [ \begin{matrix}{\dot{r}}_{{0}_{T}}^{′} \\ {r}_{{0}_{T}}^{′} {\dot{θ}}_{{0}_{T}}^{′}\end{matrix} ] = [ \begin{matrix}{V}_{T} \\ 0\end{matrix} ]\end{matrix} \qquad 69$$

which in terms of the instantaneous centre of rotation velocity components yields,

$$[ \begin{matrix}{\dot{r}}_{T} \\ {r}_{T} \cdot {\dot{θ}}_{L}^{′}\end{matrix} ] = {V}_{T} [ \begin{matrix}Cos ( {θ}_{L}^{′} ) \\ - Sin ( {θ}_{L}^{′} )\end{matrix} ] + [ \begin{matrix}- Cos ( {θ}_{L}^{′} + {θ}_{{0}_{T}}^{′} ) & Sin ( {θ}_{L}^{′} + {θ}_{{0}_{T}}^{′} ) \\ Sin ( {θ}_{L}^{′} + {θ}_{{0}_{T}}^{′} ) & Cos ( {θ}_{L}^{′} + {θ}_{{0}_{T}}^{′} )\end{matrix} ] \cdot [ \begin{matrix}{\dot{r}}_{{0}_{T}}^{′} \\ {r}_{{0}_{T}}^{′} {\dot{θ}}_{{0}_{T}}^{′}\end{matrix} ] \qquad 70$$

Similarly for the acceleration terms,

$$\begin{matrix}[ \begin{matrix}Cos ( {θ}_{L}^{′} ) & - Sin ( {θ}_{L}^{′} ) \\ Sin ( {θ}_{L}^{′} ) & Cos ( {θ}_{L}^{′} )\end{matrix} ] \cdot [ \begin{matrix}( {\ddot{r}}_{T} - {r}_{T} \cdot {\dot{θ}}_{L}^{′ 2} ) \\ \frac{1}{{r}_{T}} \frac{\partial }{\partial t} [ {r}_{T}^{2} \cdot {\dot{θ}}_{L}^{′} ]\end{matrix} ] + \\ [ \begin{matrix}Cos ( {θ}_{{0}_{T}}^{′} ) & - Sin ( {θ}_{{0}_{T}}^{′} ) \\ - Sin ( {θ}_{{0}_{T}}^{′} ) & - Cos ( {θ}_{{0}_{T}}^{′} )\end{matrix} ] \cdot [ \begin{matrix}( {\ddot{r}}_{{0}_{T}}^{′} - {r}_{{0}_{T}}^{′} \cdot {\dot{θ}}_{{0}_{T}}^{′ 2} ) \\ \frac{1}{{r}_{{0}_{T}}^{′}} \frac{\partial }{\partial t} [ {r}_{{0}_{T}}^{′ 2} \cdot {\dot{θ}}_{{0}_{T}}^{′} ]\end{matrix} ] = [ \begin{matrix}{\dot{V}}_{T} \\ 0\end{matrix} ]\end{matrix} \qquad 71$$

which after rearranging yields

$$\begin{matrix}[ \begin{matrix}( {\ddot{r}}_{T} - {r}_{T} \cdot {\dot{θ}}_{L}^{′ 2} ) \\ \frac{1}{{r}_{T}} \frac{\partial }{\partial t} [ {r}_{T}^{2} \cdot {\dot{θ}}_{L}^{′} ]\end{matrix} ] = {\dot{V}}_{T} [ \begin{matrix}Cos ( {θ}_{L}^{′} ) \\ - Sin ( {θ}_{L}^{′} )\end{matrix} ] + \\ [ \begin{matrix}- Cos ( {θ}_{L}^{′} + {θ}_{{0}_{T}}^{′} ) & Sin ( {θ}_{L}^{′} + {θ}_{{0}_{T}}^{′} ) \\ Sin ( {θ}_{L}^{′} + {θ}_{{0}_{T}}^{′} ) & Cos ( {θ}_{L}^{′} + {θ}_{{0}_{T}}^{′} )\end{matrix} ] \cdot [ \begin{matrix}( {\ddot{r}}_{{0}_{T}}^{′} - {r}_{{0}_{T}}^{′} \cdot {\dot{θ}}_{{0}_{T}}^{′ 2} ) \\ \frac{1}{{r}_{{0}_{T}}^{′}} \frac{\partial }{\partial t} [ {r}_{{0}_{T}}^{′ 2} \cdot {\dot{θ}}_{{0}_{T}}^{′} ]\end{matrix} ]\end{matrix} \qquad 72$$

substituting for,

$${\dot{r}}_{{0}_{T}}^{′} , {r}_{{0}_{T}}^{′} {\dot{θ}}_{{0}_{T}}^{′} , ( {\ddot{r}}_{{0}_{T}}^{′} - {r}_{{0}_{T}}^{′} \cdot {\dot{θ}}_{{0}_{T}}^{′ 2} ) , \frac{1}{{r}_{{0}_{T}}^{′}} \frac{\partial }{\partial t} [ {r}_{{0}_{T}}^{′ 2} \cdot {\dot{θ}}_{{0}_{T}}^{′} ] \qquad 73$$

to yield a relationship between the velocity and acceleration components of the attacking missile and those of the target. This yields the matrix equations,

$$\begin{matrix}[ \begin{matrix}( {\ddot{r}}_{T} - {r}_{T} \cdot {\dot{θ}}_{L}^{′ 2} ) \\ \frac{1}{{r}_{T}} \frac{\partial }{\partial t} [ {r}_{T}^{2} \cdot {\dot{θ}}_{L}^{′} ]\end{matrix} ] = {\dot{V}}_{T} [ \begin{matrix}Cos ( {θ}_{L}^{′} ) \\ - Sin ( {θ}_{L}^{′} )\end{matrix} ] + [ \begin{matrix}Cos ( {θ}^{′} - {θ}_{L}^{′} ) & - Sin ( {θ}^{′} - {θ}_{L}^{′} ) \\ Sin ( {θ}^{′} - {θ}_{L}^{′} ) & Cos ( {θ}^{′} - {θ}_{L}^{′} )\end{matrix} ] \cdot [ \begin{matrix}{n}_{g} g + ( {\ddot{r}}^{′} - {r}^{′} {\dot{θ}}^{′ 2} ) \\ \frac{1}{{r}^{′}} \frac{\partial }{\partial t} [ {r}^{′ 2} \cdot {\dot{θ}}^{′} ]\end{matrix} ] & 74 \\ [ \begin{matrix}{\dot{r}}_{T} \\ {r}_{T} \cdot {\dot{θ}}_{L}^{′}\end{matrix} ] = {V}_{T} [ \begin{matrix}Cos ( {θ}_{L}^{′} ) \\ - Sin ( {θ}_{L}^{′} )\end{matrix} ] + [ \begin{matrix}- Sin ( {θ}^{′} - {θ}_{L}^{′} ) & Cos ( {θ}^{′} - {θ}_{L}^{′} ) \\ Cos ( {θ}^{′} - {θ}_{L}^{′} ) & Sin ( {θ}^{′} - {θ}_{L}^{′} )\end{matrix} ] \cdot [ \begin{matrix}( V + {r}^{′} {\dot{θ}}^{′} ) \\ {\dot{r}}^{′}\end{matrix} ] & 75\end{matrix}$$

From equations 58 and 60 the instantaneous radii are derived from the instantaneous centre of rotation to the attacking missile (r′) and the target (r_{T}) as follows,

$$\begin{matrix}{r}^{′} = \frac{Sin ( {γ}_{sl} - {θ}_{c} - α + {θ}_{L}^{′} )}{Cos ( {θ}_{c} - {θ}_{L}^{′} )} \cdot {r}_{sl} & 76 \\ {r}_{T} = \frac{Cos ( {γ}_{sl} - α )}{Cos ( {θ}_{c} - {θ}_{L}^{′} )} \cdot {r}_{sl} & 77\end{matrix}$$

and from equation 75,
\dot{r}_{T}=V_{T} Cos(θ′ₗ)−(V+r′\dot{θ}_{c}).Cos(θ_{c}−θ′_{L})−\dot{r}′ Sin((θ_{c}−θ′_{L}) 78

Differentiating the equation for r′ in equation 76 above results in the following expression;

$${\dot{r}}^{′} Cos ( {θ}_{c} - {θ}_{L}^{′} ) = \frac{( ( - {\dot{θ}}_{c} + {\dot{θ}}_{L}^{′} ) \cdot {r}_{sl} \cdot Cos ( {γ}_{sl} - α ) )}{Cos ( {θ}^{′} - {θ}_{L}^{′} )} + {\dot{γ}}_{sl} \cdot {r}_{sl} \cdot Cos ( {γ}_{sl} - {θ}_{c} - α + {θ}_{L}^{′} ) + {\dot{r}}_{sl} \cdot Sin ( {γ}_{sl} - {θ}_{c} - α + {θ}_{L}^{′} ) - \dot{α} \cdot {r}_{sl} \cdot Cos ( {γ}_{sl} - {θ}_{c} - α + {θ}^{′} ) \qquad 79$$

Substituting for,
r′, i′, r_{T}, i_{T} 80
in the equation for \dot{γ}ₛₗ (equation 59) and rearranging then yields,

$${\dot{θ}}_{c} = ( {\dot{γ}}_{sl} - \dot{α} ) - \frac{( \frac{{\dot{r}}_{sl}}{{r}_{sl}} )}{Tan ( {γ}_{sl} - α - {θ}_{c} + {θ}_{L}^{′} )} - ( \frac{V \cdot Cos ( {θ}_{c} - {θ}_{L}^{′} ) - {V}_{T} \cdot Cos ( {θ}_{L}^{′} )}{{r}_{sl} \cdot Sin ( {γ}_{sl} - α - {θ}_{c} + {θ}_{L}^{′} )} ) \qquad 81$$

If we now consider instantaneous motion in an arc of a circle, the number of g's pulled (no is directly related to the flight path rate \dot{θ}_{c} and the speed (here considered to be a constant V) by the expression,
n_{g}g=−\dot{θ}_{c}.V 82

It therefore follows that the demand g to achieve intercept with a moving target is instantaneously given by the expression,

$${n}_{g} = - ( \frac{V}{g} ) \cdot [ \begin{matrix}{\dot{γ}}_{sl} - \dot{α} - \frac{( \frac{{\dot{r}}_{sl}}{{r}_{sl}} )}{Tan ( {γ}_{sl} - α - {θ}_{c} + {θ}_{L}^{′} )} - \\ ( \frac{V \cdot Cos ( {θ}_{c} - {θ}_{L}^{′} ) - {V}_{T} \cdot Cos ( {θ}_{L}^{′} )}{{r}_{sl} \cdot Sin ( {γ}_{sl} - α - {θ}_{c} + {θ}_{L}^{′} )} )\end{matrix} ] \qquad 83$$

At each point of the final bunt trajectory, the missile rotates about the instantaneous centre of rotation and that the instantaneous radius from this centre to the missile is equal to that radius from the centre to the target, then r′=r_{T} from above. This is in keeping with our outline philosophy given in section 2. As a result R=r′=r_{T} from which assumption it follows that,

$$R = \frac{Sin ( {γ}_{sl} - {θ}_{c} - α + {θ}_{L}^{′} )}{Cos ( {θ}_{c} - {θ}_{L}^{′} )} \cdot {r}_{sl} = \frac{Cos ( {γ}_{sl} - α )}{Cos ( {θ}_{c} - {θ}_{L}^{′} )} \cdot {r}_{sl} \qquad 84$$

From equation 84 it then follows that,
Sin(γₛₗ−θ_{c}−α+θ′_{L})=Cos(γₛₗ−α) 85

Solving this equation then yields the solution for θ′_{L}, as

$${θ}_{L}^{′} = \frac{π}{2} \pm ( {γ}_{sl} - α ) - {γ}_{sl} + {θ}_{c} + α \qquad 86$$

Note there are two possible solutions,

$$\begin{matrix}{θ}_{{L}_{1}} = \frac{π}{2} + {θ}_{c} , & {θ}_{{L}_{2}} = \frac{π}{2} + {θ}_{c} - 2 ( {γ}_{sl} - α )\end{matrix} \qquad 87$$

Of these two solutions, solution I refers to the condition for the radius vector from the instantaneous centre of rotation to the target at the point of impact and solution 2 is the arbitrary case for the missile in flight during the bunt. It should be noted in this case that despite assuming (for the purposes of the algorithm) that the two radii are instantaneously of the same length, they are allowed to vary in length at the same rate throughout the bunt trajectory.

In keeping with the generalised analysis, only the second solution will be considered from here. Thus substituting for solution 2 in the expression for R it follows that,

$$α = {γ}_{sl} - {Sin}^{- 1} ( \frac{{r}_{sl}}{2 R} ) \qquad 88$$

and for the manoeuvre g,

$${n}_{g} = - ( \frac{V}{g} ) \cdot [ ( {\dot{γ}}_{sl} - \dot{α} ) - ( \frac{{\dot{r}}_{sl}}{{r}_{sl}} ) \cdot Tan ( {γ}_{sl} - α ) - ( \frac{V \cdot Sin ( 2 \cdot ( {γ}_{sl} - α ) ) - {V}_{T} \cdot Sin ( {θ}_{c} - 2 \cdot ( {γ}_{sl} - α ) )}{{r}_{sl} \cdot Cos ( {γ}_{sl} - α )} ) ] \qquad 89$$

Also since we are concerned with instantaneous motion in an arc of a circle at constant speed V, it follows that,
V=−\dot{θ}_{c}.R 90

Substituting for R then yields,

$$α = {γ}_{sl} + {Sin}^{- 1} ( \frac{{r}_{sl} \cdot {\dot{θ}}_{c}}{2 V} ) \qquad 91$$

It follows from equation 91 that as rₛₗ [symbol] 0, so α [symbol] γₛₗ and therefore if in particular γₛₗ [symbol] 0 soα [symbol] 0. Further since \dot{θ}_{c} is related to the manoeuvre g demand to hit the target, it follows that a direct link exists to the associated incidence at impact. In summary therefore a terminal engagement algorithm which ties manoeuvre g to climb rate and sightline look angle enables the impact grazing angle to be determined (subject to tight autopilot control). Throughout the bunt, the sightline needs to maintain look angle on the target and to maintain the associated g to manoeuvre to impact translates into an associated incidence demand. If this incidence is within stall limits of all lifting surfaces while maintaining the required manoeuvre g to achieve the bunt trajectory them the terminal engagement algorithm will comply with all requirements to fly the bunt trajectory and impact the target.

In varying the incidence in this way to accommodate a manoeuvre g while maintaining sightline look on the target, it is essential that the wing-tail inter-linked gearing is continually adjusted. This will leave the residual tail control to remove any body rate transients and correct for any minor errors in achieving the required impact conditions resulting from autopilot/systems lags either inherent or resulting from atmospheric disturbance.

It should be noted in equation 89 the velocity of the target V_{T} is the instantaneous velocity of the target at the point of breakaway into the bunt and the value of manoeuvre g calculated n_{g} is that manoeuvre g which at that instant is required to describe an arc which intercepts the target at that point. However since the target continues to move, we need to apply a specific shape function for the trajectory post breakaway from the climb phase into the bunt which addresses the subsequent manoeuvre to intercept.

Specific Application of The Generic Terminal Engagement Routine

Assume the instantaneous centre of rotation of the radial vector to the attacking missile as acting along the extended pull-up radial vector assumed set at an angle θ*_{cp} equal to that angle at which breakaway takes place between the pull up, and the bunt manoeuvre. In application this may be translated into a specific sightline range which is more practical in a real world application. For now retain this convention for analytical purposes. It follows then that,

$$\begin{matrix}{\underline{V}}_{{o}_{T}}^{′} = {\dot{r}}_{cp}^{*} \cdot {\underline{k}}_{traj}^{*} & 92 \\ and , & \\ {\underline{V}}_{{O}_{T}^{′}} = [ \begin{matrix}{\dot{r}}_{{O}_{T}^{′}} & {r}_{{O}_{T}^{′}} \cdot {\dot{θ}}_{{}_{O}^{}{T}{}_{}^{′}}\end{matrix} ] \cdot [ \begin{matrix}{\underline{i}}_{{o}_{T}^{′}} \\ {\underline{k}}_{{o}_{T}^{′}}\end{matrix} ] & 93\end{matrix}$$

Transforming into trajectory axes,

$${\underline{V}}_{{O}_{T}^{′}} = [ \begin{matrix}{\dot{r}}_{{O}_{T}^{′}} & {r}_{{O}_{T}^{′}} \cdot {\dot{θ}}_{{}_{O}^{}{T}{}_{}^{′}}\end{matrix} ] \cdot [ \begin{matrix}Cos ( {θ}_{{O}_{T}} ) & - Sin ( {θ}_{{O}_{T}} ) \\ - Sin ( {θ}_{{O}_{T}} ) & - Cos ( {θ}_{{O}_{T}} )\end{matrix} ] \cdot \\ [ \begin{matrix}Cos ( {θ}_{c}^{*} ) & Sin ( {θ}_{c}^{*} ) \\ Sin ( {θ}_{c}^{*} ) & - Cos ( {θ}_{c}^{*} )\end{matrix} ] \cdot [ \begin{matrix}{\underline{i}}_{traj}^{*} \\ {\underline{k}}_{traj}^{*}\end{matrix} ] \qquad 94$$

Rearranging equations 92, 93 and 94 then yields,

$$[ \begin{matrix}{\dot{r}}_{{0}_{T}^{′}} \\ {r}_{{0}_{T}^{′}} \cdot {\dot{θ}}_{{0}_{T}^{′}}\end{matrix} ] = [ \begin{matrix}Cos ( {θ}_{{0}_{T}^{′}} + {θ}_{c}^{*} ) & Sin ( {θ}_{{0}_{T}^{′}} + {θ}_{c}^{*} ) \\ - Sin ( {θ}_{{0}_{T}^{′}} + {θ}_{c}^{*} ) & Cos ( {θ}_{{0}_{T}^{′}} + {θ}_{c}^{*} )\end{matrix} ] \cdot [ \begin{matrix}0 \\ {\dot{r}}_{cp}^{*}\end{matrix} ] \qquad 95$$

But it can be shown that,

$$[ \begin{matrix}{\dot{r}}_{T} \\ {r}_{T} \cdot {\dot{θ}}_{L}^{′}\end{matrix} ] = {V}_{T} [ \begin{matrix}Cos ( {θ}_{L}^{′} ) \\ - Sin ( {θ}_{L}^{′} )\end{matrix} ] + [ \begin{matrix}- Cos ( {θ}_{L}^{′} + {θ}_{{0}_{T}}^{′} ) & Sin ( {θ}_{L}^{′} + {θ}_{{0}_{T}}^{′} ) \\ Sin ( {θ}_{L}^{′} + {θ}_{{0}_{T}}^{′} ) & Cos ( {θ}_{L}^{′} + {θ}_{{0}_{T}}^{′} )\end{matrix} ] \cdot [ \begin{matrix}{\dot{r}}_{{0}_{T}}^{′} \\ {r}_{{0}_{T}}^{′} {\dot{θ}}_{{0}_{T}}^{′}\end{matrix} ] \qquad 96$$

Substituting this expression in equation 70 yields,

$$[ \begin{matrix}{\dot{r}}_{T} \\ {r}_{T} \cdot {\dot{θ}}_{L}^{′}\end{matrix} ] = {V}_{T} \cdot [ \begin{matrix}Cos ( {θ}_{L}^{′} ) \\ - Sin ( {θ}_{L}^{′} )\end{matrix} ] + [ \begin{matrix}- Cos ( {θ}_{c}^{*} - {θ}_{L}^{′} ) & - Sin ( {θ}_{c}^{*} - {θ}_{L}^{′} ) \\ - Sin ( {θ}_{c}^{*} - {θ}_{L}^{′} ) & Cos ( {θ}_{c}^{*} - {θ}_{L}^{′} )\end{matrix} ] \cdot [ \begin{matrix}0 \\ {\dot{r}}_{cp}^{*}\end{matrix} ] \qquad 97$$

From equation 75 now repeated here for ease of reference,

$$[ \begin{matrix}{\dot{r}}_{T} \\ {r}_{T} \cdot {\dot{θ}}_{L}^{′}\end{matrix} ] = {V}_{T} [ \begin{matrix}Cos ( {θ}_{L}^{′} ) \\ - Sin ( {θ}_{L}^{′} )\end{matrix} ] + [ \begin{matrix}- Sin ( {θ}^{′} - {θ}_{L}^{′} ) & Cos ( {θ}^{′} - {θ}_{L}^{′} ) \\ Cos ( {θ}^{′} - {θ}_{L}^{′} ) & Sin ( {θ}^{′} - {θ}_{L}^{′} )\end{matrix} ] \cdot [ \begin{matrix}( V + {r}^{′} {\dot{θ}}^{′} ) \\ {\dot{r}}^{′}\end{matrix} ] \qquad 98$$

Equating equations 97 and 98 and rearranging yields the relationship,

$$[ \begin{matrix}V + {r}^{′} {\dot{θ}}^{′} \\ {\dot{r}}^{′}\end{matrix} ] = [ \begin{matrix}- Sin ( {θ}_{c}^{*} - {θ}^{′} ) & Cos ( {θ}_{c}^{*} - {θ}^{′} ) \\ - Cos ( {θ}_{c}^{*} - {θ}^{′} ) & - Sin ( {θ}_{c}^{*} - {θ}^{′} )\end{matrix} ] \cdot [ \begin{matrix}0 \\ {\dot{r}}_{cp}^{*}\end{matrix} ] \qquad 99$$

It is assumed that at any instant in time,
R=r′=r_{T}, \dot{R}=\dot{r}′=\dot{r}_{T} 100

In this assumption, the rate of change of radius is none zero.
\dot{R}=V_{T}.Cos(θ_{L}′)″\dot{r}*_{cp} Sin(θ*_{c}−θ_{L}′)=−Sin(θ*_{c}−θ′).\dot{r}*_{cp} 101

Hence,

$$\dot{R} = \frac{- {V}_{T} \cdot Sin ( {θ}_{c}^{*} - {θ}^{′} ) \cdot Cos ( {θ}_{L}^{′} )}{[ Sin ( {θ}_{c}^{*} - {θ}_{L}^{′} ) - Sin ( {θ}_{c}^{*} - {θ}^{′} ) ]} \qquad 102$$

Motion in an instantaneous arc of a circle during the bunt phase results in the following equation,

$$R = ( \frac{{r}_{sl}}{2 \cdot Sin ( {γ}_{sl} - α )} ) \qquad 103$$

Differentiating then yields,

$$\frac{\dot{R}}{R} = \frac{{\dot{r}}_{sl}}{{r}_{sl}} - \frac{( {\dot{γ}}_{sl} - \dot{α} )}{Tan ( {γ}_{sl} - α )} \qquad 104$$

Substituting for equations 102, 103 and utilising the general solution for θ_{L}′=π/2+θc−2(γsl−c) and the substitution for θ′=π/2+θc,

$$\begin{matrix}\frac{\dot{R}}{R} = \frac{{\dot{r}}_{sl}}{{r}_{sl}} - \frac{( {\dot{γ}}_{sl} - \dot{α} )}{Tan ( {γ}_{sl} - α )} \\ = - \frac{2 \cdot {V}_{T} \cdot Sin ( {γ}_{sl} - α ) \cdot Cos ( {θ}_{c} - {θ}_{c}^{*} ) \cdot Sin ( {θ}_{c} - 2 \cdot ( {γ}_{sl} - α ) )}{{r}_{sl} \cdot [ Cos ( {θ}_{c} - {θ}_{c}^{*} ) - Cos ( ( {θ}_{c} - {θ}_{c}^{*} ) - 2 \cdot ( {γ}_{sl} - α ) ) ]}\end{matrix} \qquad 105$$

Whereupon the final version of the terminal engagement routine becomes

$$ng = ( \frac{V}{g} ) [ \frac{\begin{matrix}- 2 \cdot {V}_{T} \cdot Sin ( {γ}_{sl} - α ) \cdot Tan ( {γ}_{sl} - α ) \\ Cos ( {θ}_{c} - {θ}_{c}^{*} ) \cdot Sin ( {θ}_{c} - 2 \cdot ( {γ}_{sl} - α ) )\end{matrix}}{{r}_{sl} \cdot [ Cos ( {θ}_{c} - {θ}_{c}^{*} ) - Cos ( ( {θ}_{c} - {θ}_{c}^{*} ) - 2 \cdot ( {γ}_{sl} - α ) ) ]} + ( \frac{V \cdot Sin ( 2 \cdot ( {γ}_{sl} - α ) ) - {V}_{T} \cdot Sin ( {θ}_{c} - 2 \cdot ( {γ}_{sl} - α ) )}{{r}_{sl} \cdot Cos ( {γ}_{sl} - α )} ) ] \qquad 106$$

Note here that θ*_{c} relates to the climb angle into pull-up at which breakaway occurs into the bunt.

Rearranging this equation to be in the form,

$$ng = ( \frac{V}{g \cdot {r}_{sl}} ) [ \frac{\begin{matrix}- 2 \cdot {V}_{T} \cdot Sin ( {γ}_{sl} - α ) \cdot Tan ( {γ}_{sl} - α ) \\ Cos ( ( θ - α ) - ( {θ}^{*} - {α}^{*} ) ) \cdot Sin ( ( θ - α ) - 2 \cdot ( {γ}_{sl} - α ) )\end{matrix}}{[ \begin{matrix}Cos ( ( θ - α ) - ( {θ}^{*} - {α}^{*} ) ) - \\ Cos ( ( ( θ - α ) - ( {θ}^{*} - {α}^{*} ) ) - 2 ( {γ}_{sl} - α ) )\end{matrix} ]} + ( \frac{V \cdot Sin ( 2 ( {γ}_{sl} - α ) ) - {V}_{T} \cdot Sin ( ( θ - α ) - 2 ( {γ}_{sl} - α ) )}{Cos ( {γ}_{sl} - α )} ) ] \qquad 107$$

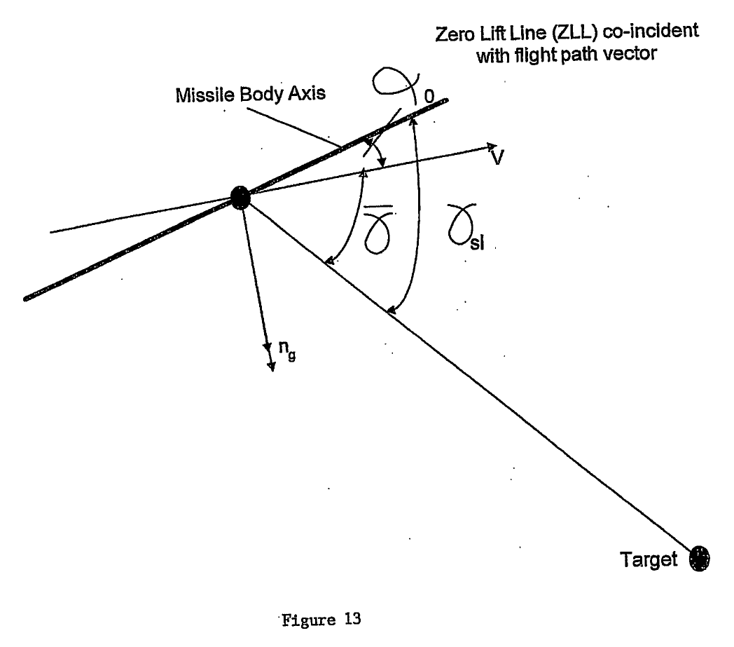

At any point in the trajectory, control to achieve an implied α=α₀ (i.e. appropriate ZLL) since the sightline angle γₛₗ minus this angle is constant at the same point, it opens the possibility of varying a demand ZLL to achieve a favourable look angle to the target while ensuring manoeuvre potential below the stall. Note here that the ZLL is implied to act along the flight velocity vector. The remaining terms in the expression which concern body attitude can be derived by integration of body rate from rate gyros via the autopilot. Terms marked with an ‘asterisk’ concern conditions at breakaway from the pull-up manoeuvre when entering the bunt phase. These may be identified at a specific sightline range to target intercept. These features are expressed graphically in FIG. 13.

Transformation Matrices

In defining the routine, use is made of several axes sets as defined in FIG. 10. For convenience, axes transformations between these sets needed in the analysis are summarised below.

Transformation of axes iₜᵣₐⱼ, kₜᵣₐⱼ to i_{B}, k_{B} and visa versa through angular rotation α (angle of attack).

$$[ \begin{matrix}{\underline{i}}_{traj} \\ {\underline{k}}_{traj}\end{matrix} ] = [ \begin{matrix}Cos ( α ) & Sin ( α ) \\ - Sin ( α ) & Cos ( α )\end{matrix} ] \cdot [ \begin{matrix}{\underline{i}}_{B} \\ {\underline{k}}_{B}\end{matrix} ] , \\ [ \begin{matrix}{\underline{i}}_{B} \\ {\underline{k}}_{B}\end{matrix} ] = [ \begin{matrix}Cos ( α ) & - Sin ( α ) \\ Sin ( α ) & Cos ( α )\end{matrix} ] \cdot [ \begin{matrix}{\underline{i}}_{traj} \\ {\underline{k}}_{traj}\end{matrix} ] \qquad 108$$

Transformation of axes iₜᵣₐⱼ, kₜᵣₐⱼ to i, k⁻ and visa versa through angular rotation θ′.

$$[ \begin{matrix}{\underline{i}}_{traj} \\ {\underline{k}}_{traj}\end{matrix} ] = [ \begin{matrix}Sin ( {θ}^{′} ) & - Cos ( {θ}^{′} ) \\ - Cos ( {θ}^{′} ) & - Sin ( {θ}^{′} )\end{matrix} ] \cdot [ \begin{matrix}\underline{i} \\ {\underline{k}}^{-}\end{matrix} ] , \\ [ \begin{matrix}\underline{i} \\ {\underline{k}}^{-}\end{matrix} ] = [ \begin{matrix}Sin ( {θ}^{′} ) & - Cos ( {θ}^{′} ) \\ - Cos ( {θ}^{′} ) & - Sin ( {θ}^{′} )\end{matrix} ] \cdot [ \begin{matrix}{\underline{i}}_{traj} \\ {\underline{k}}_{traj}\end{matrix} ] \qquad 109$$

Transformation of axes i, k⁻ to i₁, k₁ and visa versa through angular rotation θ₁.

$$[ \begin{matrix}\underline{i} \\ {\underline{k}}^{-}\end{matrix} ] = [ \begin{matrix}Cos ( θ ) & Sin ( {θ}_{1} ) \\ Sin ( {θ}_{1} ) & - Cos ( θ )\end{matrix} ] \cdot [ \begin{matrix}{\underline{i}}_{1} \\ {\underline{k}}_{1}\end{matrix} ] , \\ [ \begin{matrix}{\underline{i}}_{1} \\ {\underline{k}}_{1}\end{matrix} ] = [ \begin{matrix}Cos ( θ ) & Sin ( {θ}_{1} ) \\ Sin ( {θ}_{1} ) & - Cos ( θ )\end{matrix} ] \cdot [ \begin{matrix}\underline{i} \\ {\underline{k}}^{-}\end{matrix} ] \qquad 110$$

Transformation of axes i, k⁻ to iₜᵣₐⱼ, kₜᵣₐⱼ and visa versa through angular rotation θ_{c}.

$$[ \begin{matrix}\underline{i} \\ {\underline{k}}^{-}\end{matrix} ] = [ \begin{matrix}Cos ( {θ}_{c} ) & Sin ( {θ}_{c} ) \\ Sin ( {θ}_{c} ) & - Cos ( {θ}_{c} )\end{matrix} ] \cdot [ \begin{matrix}{\underline{i}}_{traj} \\ {\underline{k}}_{traj}\end{matrix} ] , \\ [ \begin{matrix}{\underline{i}}_{traj} \\ {\underline{k}}_{traj}\end{matrix} ] = [ \begin{matrix}Cos ( {θ}_{c} ) & Sin ( {θ}_{c} ) \\ Sin ( {θ}_{c} ) & - Cos ( {θ}_{c} )\end{matrix} ] \cdot [ \begin{matrix}\underline{i} \\ {\underline{k}}^{-}\end{matrix} ] \qquad 111$$

Transformation of axes i, k⁻ to I_{T}, k_{T} and visa versa through angular rotation θ′_{L}.

$$[ \begin{matrix}\underline{i} \\ {\underline{k}}^{-}\end{matrix} ] = [ \begin{matrix}Cos ( {θ}_{L}^{′} ) & Sin ( {θ}_{L}^{′} ) \\ Sin ( {θ}_{L}^{′} ) & - Cos ( {θ}_{L}^{′} )\end{matrix} ] \cdot [ \begin{matrix}{\underline{i}}_{T} \\ {\underline{k}}_{T}\end{matrix} ] , \\ [ \begin{matrix}{\underline{i}}_{T} \\ {\underline{k}}_{T}\end{matrix} ] = [ \begin{matrix}Cos ( {θ}_{L}^{′} ) & Sin ( {θ}_{L}^{′} ) \\ Sin ( {θ}_{L}^{′} ) & - Cos ( {θ}_{L}^{′} )\end{matrix} ] \cdot [ \begin{matrix}\underline{i} \\ {\underline{k}}^{-}\end{matrix} ] \qquad 112$$

Transformation of axes i, k⁻ to i_{OT}′, k_{OT}, and visa versa through angular rotation θ_{OT′}.

$$[ \begin{matrix}\underline{i} \\ {\underline{k}}^{-}\end{matrix} ] = [ \begin{matrix}Cos ( {θ}_{{O}_{{T}^{′}}} ) & - Sin ( {θ}_{{O}_{{T}^{′}}} ) \\ - Sin ( {θ}_{{O}_{{T}^{′}}} ) & - Cos ( {θ}_{{O}_{{T}^{′}}} )\end{matrix} ] \cdot [ \begin{matrix}{\underline{i}}_{{OT}^{′}} \\ {\underline{k}}_{{OT}^{′}}\end{matrix} ] , \\ [ \begin{matrix}{\underline{i}}_{{OT}^{′}} \\ {\underline{k}}_{{OT}^{′}}\end{matrix} ] = [ \begin{matrix}Cos ( {θ}_{{O}_{{T}^{′}}} ) & - Sin ( {θ}_{{O}_{{T}^{′}}} ) \\ - Sin ( {θ}_{{O}_{{T}^{′}}} ) & - Cos ( {θ}_{{O}_{{T}^{′}}} )\end{matrix} ] \cdot [ \begin{matrix}\underline{i} \\ {\underline{k}}^{-}\end{matrix} ] \qquad 113$$

Transformation of axes i, k⁻ to i_{cp}, k_{cp} and visa versa through angular rotation θ_{cp}.

$$[ \begin{matrix}\underline{i} \\ {\underline{k}}^{-}\end{matrix} ] = [ \begin{matrix}Sin ( {θ}_{cp} ) & Cos ( {θ}_{cp} ) \\ - Cos ( {θ}_{cp} ) & Sin ( {θ}_{cp} )\end{matrix} ] \cdot [ \begin{matrix}{\underline{i}}_{cp} \\ {k}_{{\_}_{cp}}\end{matrix} ] , \\ [ \begin{matrix}{\underline{i}}_{cp} \\ {k}_{{\_}_{cp}}\end{matrix} ] = [ \begin{matrix}Sin ( {θ}_{cp} ) & - Cos ( {θ}_{cp} ) \\ Cos ( {θ}_{cp} ) & Sin ( {θ}_{cp} )\end{matrix} ] \cdot [ \begin{matrix}\underline{i} \\ {\underline{k}}^{-}\end{matrix} ] \qquad 114$$

Transformation of axes (iₜᵣₐⱼ, kₜᵣₐⱼ) to (i′, k′) and visa versa.

$$[ \begin{matrix}{\underline{i}}^{′} \\ \underline{{k}^{′}}\end{matrix} ] = [ \begin{matrix}0 & - 1 \\ 1 & 0\end{matrix} ] \cdot [ \begin{matrix}{\underline{i}}_{traj} \\ {\underline{k}}_{traj}\end{matrix} ] , \\ [ \begin{matrix}{\underline{i}}_{traj} \\ {\underline{k}}_{traj}\end{matrix} ] = [ \begin{matrix}0 & 1 \\ - 1 & 0\end{matrix} ] \cdot [ \begin{matrix}{\underline{i}}^{′} \\ \underline{{k}^{′}}\end{matrix} ] \qquad 115$$

1. A control system for a craft having two wing control surfaces spaced apart along a main body section of the craft, the system comprising automated synchronized operation of the two wing control surfaces for continuous variable displacement in flight for manoeuvre of the main body relative to the flight path velocity vector with control to a predetermined angle of attack and attitude relationship.

2. A control system according to claim 1, comprising automated synchronized operation of the two wing control surfaces for continuous variable displacement in flight for manoeuvre of the main body relative to the flight path velocity vector with control to a predetermined angle of attack to maintain continuously at zero value under sustained manoeuvre through to target intercept at zero grazing incidence.

3. A control system for a craft according to claim 1 comprising means for automated synchronized operation of the two wing control surfaces to maintain continuous variable displacement of each wing control surface via independent actuation under the action of a control routine.

4. A control system for a craft according to claim 1 comprising means for independent actuation of both wings under a control routine involving a soft actuation mechanism.

5. A control system for a craft according to claim 1 comprising means for a demand manoeuvre to act along an axis normal to a Zero Lift Line and in the plane of manoeuvre.

6. A control system for a craft according to claim 1 wherein the Zero Lift Line comprises a line co-incident with the local wind axis velocity vector, acting in the plane of manoeuvre in which the two wing control surfaces are deflected and about which there is no net normal force and moment.

7. A control system for a craft according to claim 1 comprising means to manoeuvre comprising additional automated synchronized control deflection of both wings acting normal to the Zero Lift Line in the plane of manoeuvre under the action of a control routine.

8-10. (canceled)

11. A control system for a craft according to claim 1 wherein the craft is an aircraft, marine craft or UAV and wherein the control routine is operable to continually control both wings control surfaces to manoeuvre the craft to maintain optimal forward directional visibility.

12. (canceled)

13. A control system for a craft according to claim 1 where the craft is a guided missile or torpedo in which the control routine is operable to drive the body axis under manoeuvre to coincide with the flight path velocity vector to achieve zero angle of incidence (zero grazing incidence) at target impact for maximum warhead effectiveness.

14-18. (canceled)

19. A control system for a craft according to claim 1 wherein substantially all of a control surface is moveable under the automated synchronised operation.

20-21. (canceled)

22. A control system for a craft according to claim 1 wherein the craft comprises a marine craft.

23. A control system for a craft according to claim 1 wherein the craft comprises a missile.

24. A control system for a craft according to claim 1 wherein the craft comprises a torpedo.

25. A control system for a craft according to claim 1 wherein the craft is unmanned.

26-28. (canceled)

29. A control system for a craft according to claim 1 comprising means to adjust, at an instant in time, the control surfaces setting to effect configuration of the Zero Lift Line and initiate manoeuvre relative to the Zero Lift Line in any plane of manoeuvre.

30. A control system for a craft according to claim 1 having a controller to provide, selectively as required:
constant speed;
variable speed;
proportional rotation and/or translation movement of control surfaces under independent actuation;
geared rotational and/or translational movement of control surfaces under independent actuation;
variable rotational and/or translational movement of control surfaces under independent actuation.

31. A craft having a control system according to claim 1.

32. A method of controlling a craft having two wing control surfaces spaced apart along a main body section of the craft, the method comprising automated synchronized operation of the two wing control surfaces for continuous variable displacement in flight for manoeuvre of the main body relative to the flight path velocity vector with control to a predetermined angle of attack and attitude relationship.

33. A method of controlling a craft according to claim 18, comprising automated synchronized operation of the two wing control surfaces for continuous variable displacement in flight for manoeuvre of the main body relative to the flight path velocity vector with control to a predetermined angle of attack to maintain continuously at zero value under sustained manoeuvre through to target intercept at zero grazing incidence.

34. A method of controlling a craft according to claim 18 comprising automated synchronized operation of the two wing control surfaces to maintain continuous variable displacement of each wing via independent actuation under the action of a control routine.

35. A method of controlling a craft according to claim 18 comprising independent actuation of both wings under a control routine and involving operation of a soft actuation mechanism.

36. A method of controlling a craft according to claim 18 comprising a demand manoeuvre acting along an axis normal to a Zero Lift Line and in the place of manoeuvre is implemented.

37. A method of controlling a craft according to claim 18 wherein the Zero Lift Line comprises a line co-incident with the local wind axis velocity vector, acting in the plane of manoeuvre in which the two wings are deflected and about which there is no net normal force and moment.

38. A method of controlling a craft according to claim 18 comprising additional automated synchronized control deflection of both wings acting normal to the Zero Lift Line in the plane of manoeuvre under the action of a control algorithm routine.

39-41. (canceled)

42. A method of controlling a craft according to claim 18 wherein the craft is an aircraft, marine craft or UAV and the method comprising continually controlling both wing control surfaces to manoeuvre the craft for optimal forward directional visibility.

43. (canceled)

44. A method of controlling a craft according to claim 18 wherein the craft is a guided missile or torpedo and the method comprising driving the body axis under manoeuvre to coincide with the flight path velocity vector for zero angle of incidence (zero grazing incidence) at target impact for maximum warhead effectiveness.

45-49. (canceled)

50. A method of controlling according to claim 18 comprising moving substantially all of a control surface moveable under the automated synchronised operation.

51-52. (canceled)

53. A method of controlling a craft according to claim 18 wherein the craft comprises a marine craft.

54. A method of controlling a craft according to claim 18 wherein the craft comprises a missile.

55. A method of controlling a craft according to claim 18 wherein the craft comprises a torpedo.

56. A method of controlling a craft according to claim 18 wherein the craft is unmanned.

57-59. (canceled)

60. A method of controlling a craft according to claim 18 comprising adjusting, at an instant in tine, the control surfaces setting to effect configuration of the Zero Lift Line and initiate manoeuvre relative to the Zero Lift Line in any plane of manoeuvre.

61. A method of controlling a craft according to claim 18 comprising operating a controller to provide, selectively as required:
constant speed;
variable speed;
proportional rotation and/or translation movement of control surfaces under independent actuation;
geared rotational and/or translational movement of control surfaces under independent actuation;
variable rotational and/or translational movement of control surfaces under independent actuation.

62. (canceled)

63. A computer program product directly loadable into the internal memory of a digital computer, comprising software code portions for performing the method claim 18 when said product is run on a computer.

64. A computer program directly loadable into the internal memory of a digital computer, comprising software code portions for performing the method of claim 18 when said program is run on a computer.

65. A carrier, which may comprise electronic signals, for a computer program of claim 35.

66. Electronic distribution of a computer program product of claim 35.
